(19) United States
(12) Patent Application Publication
(10) Pub. No.: US 2026/0078027 A1
(43) Pub. Date: Mar. 19, 2026

(54) SYSTEM FOR DESALINATING WATER WITH VACUUM MEMBRANE DISTILLATION

(71) Applicant: KING FAHD UNIVERSITY OF PETROLEUM AND MINERALS, Dhahran (SA)

(72) Inventors: Mohamed Abdallah Fahmy KOTB, Dhahran (SA); Atia Esmaeil Atia KHALIFA, Dhahran (SA); Mohamed Abdelkarim ANTAR, Dhahran (SA); Mohamed Atia Esmaeil KHALIFA, Dhahran (SA)

(73) Assignee: KING FAHD UNIVERSITY OF PETROLEUM AND MINERALS, Dhahran (SA)

(21) Appl. No.: 18/905,059

(22) Filed: Oct. 2, 2024

(30) Foreign Application Priority Data
Sep. 19, 2024 (SA) 1020245240

(51) Int. Cl. C02F 1/44; C02F 1/26; C02F 101/10

(52) U.S. Cl. CPC C02F 1/447; C02F 1/265; C02F 2101/10; C02F 2201/004

(57) ABSTRACT

A system for desalinating water using membrane distillation (MD) integrated with an ejector includes an ejector module and a membrane module. The ejector module includes a water ejector, a first water circulation pump, and a freshwater tank. Freshwater is continuously pumped from the freshwater tank, through the water ejector, and back to the freshwater tank. The membrane module includes a feed tank, a second water circulation pump, a water heater, and a membrane distillation unit. Salt water from the feed tank is pumped through the water heater to form vapor, which is then directed to the membrane distillation unit. The membrane distillation unit comprises a feed chamber, a membrane, and a vapor chamber. Vapor passes through the membrane to the vapor chamber connected to the water ejector. The vapor chamber, under a vacuum, does not include an outlet configured to receive a sweeping gas.

### CROSS-REFERENCE TO RELATED APPLICATIONS

The present disclosure claims the benefit of Saudi Patent Application No. 1020245240, filed on September 19, 2024, with the Saudi Authority for Intellectual Property Office, which is incorporated herein by reference in its entirety.

### BACKGROUND

### TECHNICAL FIELD

The present disclosure relates to water desalination systems, more specifically to a system for desalinating water using vacuum membrane distillation in conjunction with an ejector module to enhance vapor transfer and improve energy efficiency.

### DESCRIPTION OF RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Water desalination technologies are widely utilized for addressing the global demand for fresh water, especially in regions where natural fresh water resources are scarce or non-existent. Among various desalination methods, membrane distillation has emerged as a promising technology due to its potential of lower energy consumption and capability to operate effectively at lower temperatures compared to traditional distillation and reverse osmosis processes. Membrane distillation (MD) is a thermally driven membrane separation method used in water desalination to separate water vapor from a feed water solution. A heated saline or brackish feed water is passed over a micro-porous hydrophobic membrane in an MD module feed chamber. The temperature difference between the two sides of the membrane creates a vapor pressure difference, allowing water vapor to pass through the membrane pores from the hot feed side to the permeate side. For example, in vacuum membrane distillation (VMD), the vapor is separated from liquid feed water using a hydrophobic membrane in a reduced-pressure environment; a vacuum pump is employed on the permeate side of the membrane to evacuate the vapor for condensation in an external condenser. The use of a vacuum pump on the permeate side creates a driving force that enhances the transportation of vapor through the membrane, which increases process efficiency and productivity.

While membrane distillation has certain advantages over other desalination technologies, such as lower operating temperatures and the ability to treat high-salinity feed water, it has challenges that limit its wider application and efficiency. One major challenge is the energy consumption associated with creating and maintaining the vacuum. Traditional vacuum pumps can be energy-intensive and costly to operate, particularly when dealing with humid air streams. Additionally, the vacuum level must be carefully controlled to prevent membrane wetting, which can significantly reduce the system's performance and lifespan. Moreover, the scalability of vacuum-assisted MD systems can be limited by the practical and economic feasibility of implementing large-scale mechanical vacuum systems. For instance, in a sweeping gas membrane distillation (SGMD) system, the working fluid on the permeate side of the membrane is usually air, flowing on the permeate side and sweeping the vapor coming from the membrane. The air exiting the permeate side of the MD module is heated and humidified by the permeated vapor through the membrane. Then, the humid air is to be externally dehumidified using different techniques and devices. SGMD produces a vapor flux and is characterized by relatively low internal conduction heat losses. Using a vacuum pump, a vacuum can be applied in the permeate (air) channel of the SGMD module to create a low pressure behind the membrane (vacuum-assisted operation) to improve the process productivity by reducing the resistance of vapor mass transfer across the membrane. However, vacuum pumps have a lot of issues regarding their operation, maintenance, energy consumption, and capital cost. Vacuum pumps require more power to run and are only available for low and medium capacities and the cost is very high for large-scale pumps. Further, vacuum pumps require periodic maintenance when used with humid air because the vapor will condense somewhere inside the pump which results in low pump performance and decreases its lifetime.

Accordingly, it is one object of the present disclosure to provide a system for desalinating water that utilizes an ejector module in lieu of mechanical vacuum pumps to create the necessary vacuum effect for efficient membrane distillation. This approach aims to reduce energy consumption, reduce maintenance requirements, and improve system scalability, offering a more sustainable and cost-effective solution for water desalination.

### SUMMARY

In an exemplary embodiment, a system for desalinating water is described. The system includes a membrane module and an ejector module. The membrane module includes a feed tank configured to receive salt water, a heater configured to heat the salt water from the feed tank to form water vapor, and a membrane distillation unit including in order, a feed chamber, a membrane and a vapor chamber. The feed chamber is configured to receive the salt water and the water vapor from the heater, and the membrane is configured to let the water vapor pass from the feed chamber through the membrane to the vapor chamber. The ejector module includes an ejector including a first inlet configured to receive a primary fluid stream and a second inlet configured to receive a secondary fluid stream so that the primary fluid stream and the secondary fluid stream mix to form a mixed stream. The ejector module also includes a freshwater tank configured to receive at least the water vapor of the mixed stream. The second inlet of the ejector is connected to an outlet of the vapor chamber so that the ejector is configured to receive the water vapor from the vapor chamber as the secondary fluid stream. The vapor chamber does not include an outlet that is configured to receive a sweeping gas. The vapor chamber is under a vacuum.

In some embodiments, the ejector is configured so that the primary fluid stream accelerates within the ejector to create the vacuum to suck the secondary fluid stream from the vapor chamber.

In some embodiments, the vacuum creates or enlarges a pressure differential across the membrane between the feed chamber and the vapor chamber to suck the water vapor from the feed chamber to the vapor chamber.

In some embodiments, the system does not include a vacuum pump.

In some embodiments, the membrane is a hydrophobic microporous membrane.

In some embodiments, the membrane module further includes a water circulation pump.

In some embodiments, an outlet of the feed tank is operationally connected to an inlet of the water circulation pump. An outlet of the water circulation pump is operationally connected to an inlet of the heater. An outlet of the heater is operationally connected to an inlet of the feed chamber. An outlet of the feed chamber is operationally connected to an inlet of the feed tank.

In some embodiments, the primary fluid stream includes water, and the ejector module further includes a water circulation pump.

In some embodiments, an outlet of the freshwater tank is operationally connected to an inlet of the water circulation pump. An outlet of the water circulation pump is operationally connected to the first inlet of the ejector. An outlet of the ejector is operationally connected to an inlet of the freshwater tank.

In some embodiments, the primary fluid stream includes air, and the ejector module further includes an air blower.

In some embodiments, an inlet of the air blower is configured to receive the air from an ambient environment. An outlet of the air circulation pump is operationally connected to the first inlet of the ejector. An outlet of the ejector is operationally connected to an inlet of the freshwater tank.

In some embodiments, the system further includes a bubble column dehumidifier module that includes n number of stages. n is an integer from 1 to 100. Each stage includes a bubble column. A first stage is operationally connected to the outlet of the ejector to receive the mixed stream and is configured to capture a portion of the water vapor in the mixed stream to form desalinated water. Each bubble column includes a vapor outlet through which a portion of the water vapor that is not captured in one stage is configured to pass a next stage. Each bubble column includes a desalinated water outlet operationally connected to the freshwater tank to collect the desalinated water.

In some embodiments, the system further includes a fan that is adjacent to the bubble column dehumidifier module.

In some embodiments, the system further includes n number of thermoelectric coolers, wherein the thermoelectric coolers are each adjacent to a respective bubble column.

In some embodiments, the system further includes a water cooling system configured to provide a circulating chilled water flow to each bubble column.

In some embodiments, a vapor outlet of a bubble column of a final stage of the bubble column dehumidifier module is operationally connected to the inlet of the air blower.

In some embodiments, the membrane module further includes a power source configured to power the heater.

In some embodiments, the power source includes solar power.

In some embodiments, the system further includes a control unit configured to control at least one selected from the group consisting of a temperature of the salt water in the water heater, a flow rate of the salt water, and a water level in the feed tank.

In some embodiments, the system further includes a series of membrane distillation units connected in parallel or series.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary schematic diagram of a system for desalinating water utilizing a water ejector, according to certain embodiments.

FIG. 2 is an exemplary schematic diagram of a water desalination system utilizing a water ejector with a first side of a vapor chamber having an air inlet, according to certain embodiments.

FIG. 3 is an exemplary schematic diagram of a water desalination system with a control unit implementing a control scheme therefor, according to certain embodiments.

FIG. 4A is an exemplary schematic diagram of a water desalination system having a series of membrane distillation units connected in series, according to certain embodiments.

FIG. 4B is an exemplary schematic diagram of a water desalination system having a series of membrane distillation units connected in parallel, according to certain embodiments.

FIG. 5 is an exemplary schematic diagram of a system for desalinating water utilizing an air ejector, according to certain embodiments.

FIG. 6A is an exemplary schematic diagram of a water desalination system having a bubble column dehumidifier module with a number of stages and in which distilled water is collected from each stage as the distilled water inside each stage reaches a specific level, according to certain embodiments.

FIG. 6B is an exemplary schematic diagram of a water desalination system having a bubble column dehumidifier module with a number of stages and in which distilled water is collected from each stage at specific times, according to certain embodiments.

FIG. 7 is an exemplary schematic diagram of a water desalination system with a control unit implementing a control scheme therefor, according to certain embodiments.

FIG. 8 is an exemplary schematic diagram of a water desalination system having a fan adjacent to the bubble column dehumidifier module, according to certain embodiments.

FIG. 9 is an exemplary schematic diagram of a water desalination system with a control unit implementing a control scheme therefor, according to certain embodiments.

FIG. 10 is an exemplary schematic diagram of a water desalination system with a first side of a vapor chamber having an air inlet and implementing a closed air cycle, according to certain embodiments.

FIG. 11 is an exemplary schematic diagram of a water desalination system having a number of thermoelectric coolers, according to certain embodiments.

FIG. 12 is an exemplary schematic diagram of a water desalination system with a control unit implementing a control scheme therefor, according to certain embodiments.

FIG. 13 is an exemplary schematic diagram of a water desalination system having a bubble column dehumidifier module with a number of stages and a water cooling system, according to certain embodiments.

FIG. 14 is an exemplary schematic diagram of a water desalination system with a closed system for space cooling application, according to certain embodiments.

FIG. 15 is an exemplary schematic diagram of a water desalination system with a control unit implementing a control scheme therefor, according to certain embodiments.

FIG. 16 is an exemplary schematic diagram of a water desalination system with an integrated distillation-ejector module, according to certain embodiments.

FIG. 17 is an exemplary schematic diagram of a water desalination system with an integrated distillation-ejector module and a vapor chamber having an air inlet, according to certain embodiments.

FIG. 18 is an illustration of a non-limiting example of details of computing hardware used in the computing system, according to certain embodiments.

FIG. 19 is an exemplary schematic diagram of a data processing system used within the computing system, according to certain embodiments.

FIG. 20 is an exemplary schematic diagram of a processor used with the computing system, according to certain embodiments.

FIG. 21 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system for desalinating water that combines membrane distillation (MD) with an ejector and optionally a controller. The system can be configured as a vacuum membrane distillation (VMD) system or a sweeping gas membrane distillation (SGMD) system. In the VMD configuration, the ejector creates a vacuum in the permeate chamber of the MD module, enhancing vapor transport across the membrane. In the SGMD configuration, the ejector not only creates the vacuum but also mixes the humid air stream from the MD module with a primary fluid stream. The resulting mixture is then passed through a dehumidifier, where the water vapor is condensed and collected as fresh water. The ejector can be operated using fresh water or air as the primary fluid stream, with the extracted vapor acting as the secondary stream. The system can be further configured to implement a controller that is configured to monitor and adjust various parameters, such as pressure, temperature, and flow rates, to enhance system performance, protect the membrane, and improve freshwater production. The system is designed to be energy-efficient, utilizing the ejector to create the vacuum without the need for a conventional vacuum pump.

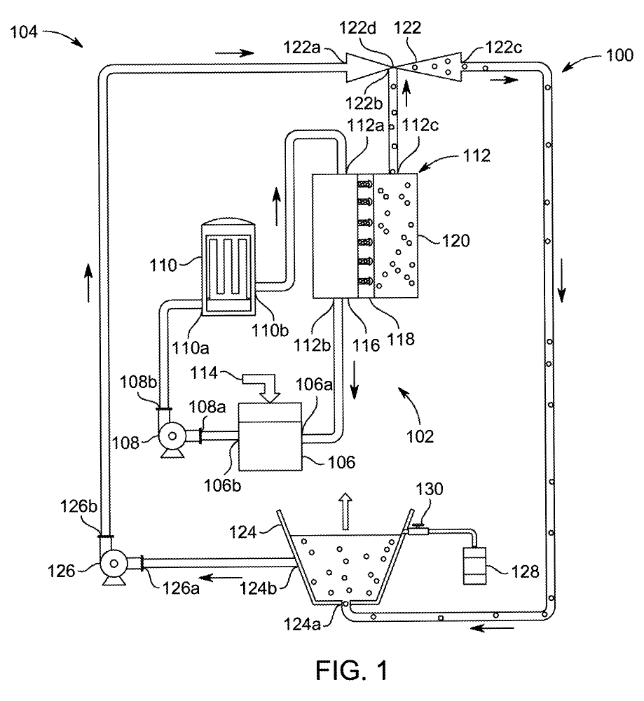

FIG. 1 illustrates a system for desalinating water (represented by reference numeral 100, and hereinafter referred to as “system 100”), according to a first embodiment of the present disclosure. The system 100 includes a membrane module 102 and an ejector module 104. The membrane module 102 is configured to separate water vapor from a saltwater feed. The ejector module 104 is configured to create a vacuum to draw the water vapor from the membrane module 102 and condense the water vapor to produce desalinated water. The incorporation of the ejector module 104 enhances the efficiency of the membrane module 102 by maintaining a reduced pressure environment. The ejector module 104 also aids in the condensation of the water vapor into liquid form, which is then collected as the desalinated water. The membrane module 102 and the ejector module 104 work together in a continuous cycle to desalinate water, with the membrane module 102 providing the water vapor and the ejector module 104 converting it into fresh water.

As illustrated, the membrane module 102 includes a feed tank 106 containing salt water, a water circulation pump 108, a water heater 110, a membrane distillation unit 112. Herein, the feed tank 106 stores the salt water and supplies it to the rest of the membrane module 102, ensuring a steady flow of feed salt water to the membrane distillation unit 112. As shown in FIG. 1, the feed tank 106 may be disposed in fluid communication with a make-up supply 114 to replenish the salt water as needed. Herein, the make-up supply 114 may be any water source that contains one or more salts such as sea water or brackish water. The water circulation pump 108 circulates the salt water from the feed tank 106 through the water heater 110 and into the membrane distillation unit 112. The water heater 110 is operationally connected to the feed tank 106 and heats the salt water to a required temperature from 50 to 90 °C, preferably from 60 to 80 °C, preferably from 65 to 75 °C. Such heating increases the vapor pressure of the salt water, which aids in driving the water vapor through the membrane distillation unit 112. The membrane distillation unit 112 is configured for the actual separation of fresh water from the salt water in the membrane module 102. The membrane module 102 further includes a power source (not shown in FIG. 1), to provide required power for operations of the water circulation pump 108 and the water heater 110.

The membrane distillation unit 112 within the membrane module 102 includes sequential components designed to facilitate the separation of fresh water from salt water through membrane distillation. In particular, the membrane distillation unit 112 includes, in order, a feed chamber 116, a membrane 118, and a vapor chamber 120. Herein, the feed chamber 116 accommodates the entry and distribution of heated salt water from the water heater 110. Here, the heated salt water encounters the membrane 118. In present embodiments, the membrane 118 is a hydrophobic microporous membrane. The hydrophobic microporous membrane 118 with its hydrophobic nature repels water molecules while allowing water vapor to pass through, thereby facilitating the separation of fresh water from salt water. Further, the microporous structure of the hydrophobic microporous membrane 118 consists of small pores that selectively permit the passage of water vapor molecules, effectively filtering out dissolved salts and other impurities present in the feed salt water. This combination of hydrophobicity and microporosity enables the membrane 118 to maintain high separation efficiency and durability over extended operational periods within the membrane distillation unit 112. Further, the vapor chamber 120 is adapted to accumulate vaporized water molecules which traversed the membrane 118. It may be noted that a continuous air stream coming usually from the ambient sweeps the permeated vapor behind the membrane 118. These vaporized water molecules are subsequently channeled out of the membrane distillation unit 112 for storage or further processing.

As will be explained later, when a primary fluid stream (e.g. water exiting from an outlet 126b of the water circulation pump 126 entering a first inlet 122a of the water ejector 122) accelerates in the water ejector 122, a vacuum can be created around a second inlet 122b of the water ejector 122 and thus in the vapor chamber 120 that is operationally connected thereto. As a result, a pressure differential can be created or enlarged across the membrane 118 between the feed chamber 116 and the vapor chamber 120 so that the water vapor is sucked from the feed chamber 116 to the vapor chamber 120 and further sucked to the second inlet 122b as a secondary fluid stream. The primary fluid stream and the secondary fluid stream can mix in the water ejector 122 and exit an outlet 122c of the water ejector 122 as a mixed stream containing the water vapor.

As the vacuum in the vapor chamber 120 can be created by the water ejector 122, a vacuum pump may not be necessary for the system 100. Additionally, the vapor chamber 120 does not include an inlet configured to receive a sweeping gas. The vapor chamber 120 is not directly connected to the ambient environment or a sweeping gas reservoir.

Further in the system 100 of FIG. 1, as illustrated, the ejector module 104 includes a water ejector 122, a freshwater tank 124, and a water circulation pump 126. Herein, the ejector module 104 is configured to utilize the kinetic energy of a high-velocity water stream to create a vacuum within the system 100. This vacuum draws water vapor through the membrane distillation unit 112, facilitating the separation of fresh water from salt water, as discussed later in more detail. The freshwater tank 124 serves as a reservoir for collecting and storing desalinated water produced by the system 100. Further, the water circulation pump 126 is configured to regulate the flow rate of water within the ejector module 104. Specifically, the water circulation pump 126 controls the circulation of water from the freshwater tank 124 to the water ejector 122, adjusting the flow rate according to operational needs to improve the vacuum generation and water vapor condensation processes. In some configurations, as shown in FIG. 1, the freshwater tank 124 may be connected to a freshwater storage 128 via an overflow valve 130. The freshwater storage 128 may act as a permanent reservoir for taking out the freshwater storage 128 from the freshwater tank 124, as much as needed, as regulated by the overflow valve 130, for storage and other purposes. In some examples, a power source (which may be same as the power source in the membrane module 102 or a separate power source) may provide required power for operations of the water circulation pump 126 in the ejector module 104.

It may be noted that, hereinafter, the water circulation pump 126 of the ejector module 104 is also referred to as first water circulation pump 126, and the water circulation pump 108 of the membrane module 102 is also referred to as second water circulation pump 108, without any limitations. Herein, at least one of the first water circulation pump 126 and the second water circulation pump 108 is configured as a variable speed pump. Such a configuration allows for precise control over the flow rate of water within their respective modules 102, 104, improving operational efficiency and energy usage. For instance, in the ejector module 104, the first water circulation pump 126 regulates the circulation of fresh water from the freshwater tank 124 to the water ejector 122. By varying the pump speed, the flow rate of the fresh water through the ejector module 104 can be regulated to adjust vacuum generation for efficient vapor condensation. Similarly, in the membrane module 102, the second water circulation pump 108 controls the circulation of salt water from the feed tank 106 through the water heater 110 and into the membrane distillation unit 112. By varying the pump speed, the flow rate of salt water can be regulated to ensure consistent heating and vapor production, as per the required operational conditions of the membrane distillation process.

In the ejector module 104 of the system 100, as illustrated, an inlet 126a of the first water circulation pump 126 is operationally connected to an outlet 124b the freshwater tank 124. An outlet 126b of the first water circulation pump 126 is operationally connected to a first inlet 122a of the water ejector 122. An outlet 122c of the water ejector 122 is operationally connected to an inlet 124a of the freshwater tank 124. Herein, the fresh water is continuously pumped throughout the ejector module 104 from the outlet 124b of the freshwater tank 124 to the inlet 124a of the freshwater tank 124. Further, in the membrane module 102 of the system 100, as illustrated, an outlet 106b of the feed tank 106 containing salt water is operationally connected to an inlet 108a of the second water circulation pump 108. An outlet 108b of the second water circulation pump 108 is operationally connected to an inlet 110a of the water heater 110 which is configured to heat a portion of the salt water from the feed tank to form vapor. An outlet 110b of the water heater 110 is operationally connected to an inlet 112a of the membrane distillation unit 112. As may be seen, the inlet 112a of the membrane distillation unit 112 is particularly located at the feed chamber 116. Also, the membrane distillation unit 112 has a first outlet 112b which is operationally connected to an inlet 106a of the feed tank 106, and a second outlet 112c which is operationally connected to a second inlet 122b of the water ejector 122. As may be seen, the first outlet 112b of the membrane distillation unit 112 is particularly located at the feed chamber 116 while the second outlet 112c of the membrane distillation unit 112 is particularly located at the vapor chamber 120.

In the system 100 of FIG. 1, the water vapor (or hereinafter “the vapor”) generated in the membrane distillation unit 112 progresses from the feed chamber 116, where it enters the membrane 118. The membrane 118, being the hydrophobic microporous membrane, selectively allows water vapor molecules to permeate while blocking the passage of salts and other impurities, ensuring the separation of fresh water from the salt water. Upon passing through the membrane 118, the vapor enters the vapor chamber 120 and accumulates as purified water vapor. The vapor chamber 120 is operationally connected to the water ejector 122 within the ejector module 104. This operational connection enables the vapor to be effectively drawn into the ejector module 104, where the vapor interacts with the continuously circulating fresh water from the freshwater tank 124. The water ejector 122 utilizes the kinetic energy of the high-velocity freshwater stream to induce a vacuum effect, facilitating the condensation of the vapor into liquid form. This condensate, now desalinated water, is subsequently collected and stored in the freshwater tank 124. It may be understood that the water vapor in the humid air coming from the membrane distillation unit 112 is condensed in the water stream and the air is then released to the atmosphere at the freshwater tank 124. The condensed water vapor in the freshwater tank 124 is then collected as a freshwater product using the overflow valve 130 (with a specified level) to the freshwater storage 128. Throughout this process, the continuous circulation of freshwater in the ejector module 104, regulated by the water circulation pump 126, ensures a consistent supply of the fresh water, as the coolant, for the condensation process. The system 100 improves the efficiency of water desalination by leveraging the vacuum created by the water ejector 122, enhancing the overall water recovery rate and reducing energy consumption and operational costs.

The system 100 of the present disclosure may not include a vacuum pump, as typically used in traditional desalination systems. Instead of relying on a vacuum pump, the system 100 employs the ejector module 104 to create and maintain the necessary vacuum conditions for the membrane distillation process. The ejector module 104 utilizes the kinetic energy of a high-velocity water stream, facilitated by the water ejector 122, to induce a vacuum effect within the vapor chamber 120. This method effectively draws water vapor through the membrane distillation unit 112, aiding in the separation of fresh water from salt water. The water ejector 122 consumes no power and has no operational costs. Thus, by eliminating the need for a vacuum pump and utilizing the water ejector 122, the system 100 significantly reduces energy consumption and operational costs associated with conventional desalination technologies. Furthermore, the absence of a vacuum pump also reduces the complexity and potential points of failure in the system 100.

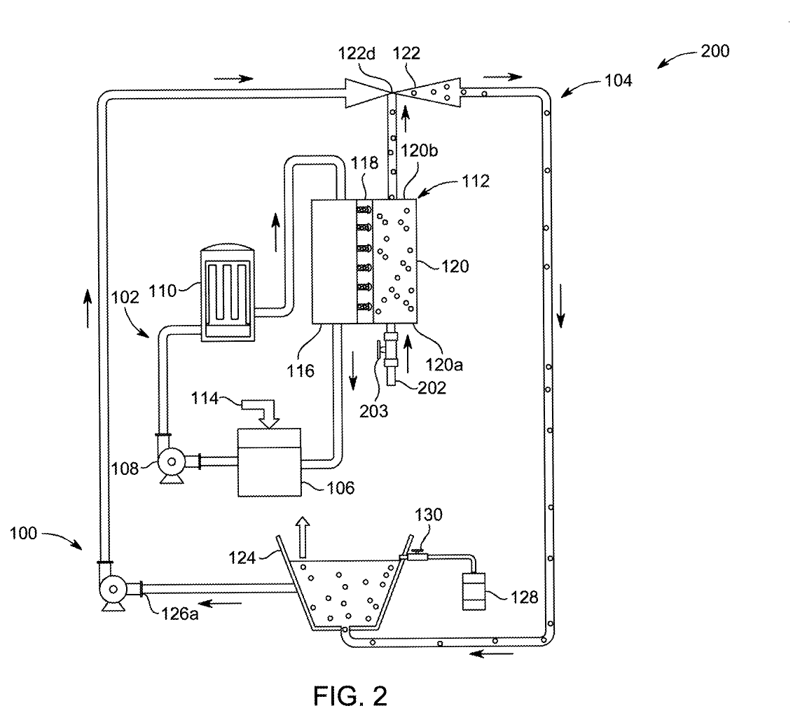

Referring to FIG. 2, illustrated is an exemplary schematic of a system for desalinating water (represented by reference numeral 200, and hereinafter referred to as “system 200”), according to a second embodiment of the present disclosure. The system 200 is similar to the system 100 of FIG. 1 in configuration, and additionally includes an air inlet 202. Note that similar or identical components are labeled with similar or identical numerals in this disclosure unless specified otherwise. Descriptions have been provided above and will be omitted for simplicity purposes.

As illustrated in FIG. 2, the air inlet 202 is positioned on a first side 120a of the vapor chamber 120 within the membrane module 102. The presence of the air inlet 202 allows for the adjustment of atmospheric pressure within the vapor chamber 120. The air inlet 202 is configured to create a pressure differential across the membrane 118 located within the membrane distillation unit 112. This pressure differential gradient aids in the facilitation of water vapor transport through the membrane 118. Further, as illustrated, a second side 120b of the vapor chamber 120, opposite to the air inlet 202, is operationally connected to the water ejector 122 of the ejector module 104. This operational connection ensures that the vaporized water molecules, having passed through the membrane 118 and accumulated in the vapor chamber 120, are efficiently drawn into the ejector module 104. Thereby in the system 200, the integration of the air inlet 202 enhances efficiency of the membrane distillation process, and thus helps in achieving improved performance in water desalination. The system 200 may not include a vacuum pump.

In some embodiments, the air inlet 202 can include a pressure valve 203 that is configured to regulate an amount of air per unit time that is drawn into the vapor chamber 120 from the ambient environment. Therefore, the pressure valve 203 can be used to adjust the pressure in the vapor chamber 120. For instance, the air inlet 202 may have a cross-sectional area of S to allow air in when the pressure valve 203 is fully open. The air inlet 202 may have a cross-sectional area of 0 to allow air in (no air will be allowed in) when the pressure valve 203 is fully closed. As a result, the air flow rate, the pressure in the vapor chamber 120 and the pressure differential across the membrane 118 can be adjusted by the pressure valve 203, in conjunction with the vacuum effect created by the water ejector 122.

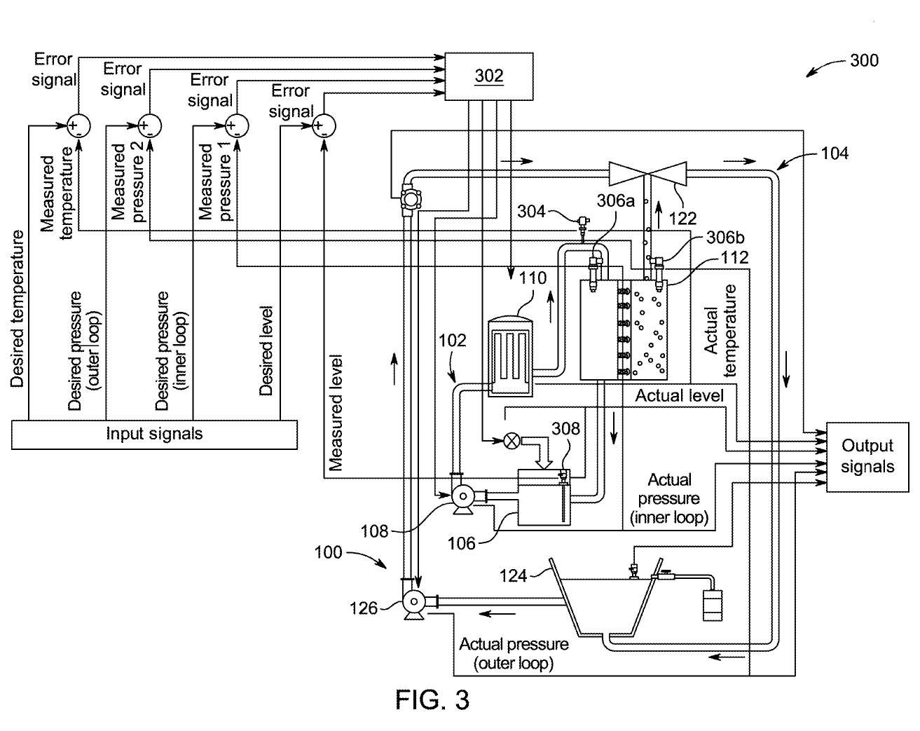

Referring to FIG. 3, illustrated is an exemplary schematic of a system for desalinating water (represented by reference numeral 300, and hereinafter referred to as “system 300”), according to a third embodiment of the present disclosure. The system 300 is similar to the system 100 of FIG. 1 in configuration, and additionally incorporates a control unit 302. The control unit 302 is configured to manage various aspects of operation of the system 300, ensuring operational conditions for efficient performance of the system 300. In particular, herein, the control unit 302 controls at least one selected from the group consisting of a temperature of the salt water in the water heater 110, a water flow rate of the first water circulation pump 126 and/or the second water circulation pump 108, and a water level in the feed tank 106. By maintaining the salt water in a pre-determined temperature range, the control unit 302 improves vaporization rates, thereby enhancing the efficiency of the membrane distillation unit 112 in separating fresh water from salt water. Also, by regulating the circulation of fresh water and salt water within their respective modules 102, 104, the control unit 302 improves energy usage and performance of the system 300 based on real-time operational demands. Further, by regulating the water level in the feed tank 106, the control unit 302 ensures a consistent and adequate supply of salt water to the membrane module 102, and thus supports continuous operation of the desalination process, reducing downtime and improving water production efficiency.

More specifically, the control unit 302 employs a closed-loop control strategy to regulate parameters of the system 300 for efficient performance. This control methodology continuously adjusts operational variables to maintain desired conditions and improve output efficiency. Firstly, the temperature of the salt water within the feed chamber 116 is regulated. This temperature directly influences the amount of vapor produced for membrane distillation. Initially, a set point temperature is established, serving as a reference for the water heater 110. The control unit 302 transmits this set point to the water heater 110, which then heats the water to achieve a desired temperature. A temperature sensor 304 measures the actual water temperature, generating an error signal that the control unit 302 uses to fine-tune operation of the water heater 110. The loop then continues until output signal related to the actual temperature aligns with the set point. Secondly, the control unit 302 controls the flow rates of two water circulation pumps 108, 126. These water circulation pumps 108, 126 adjust water circulation rates, for maintaining operational pressure differentials across the membrane distillation unit 112. Pressure sensors 306a, 306b monitor the actual pressures within the feed chamber 116 and the vapor chamber 120, respectively. The control unit 302, then, compares the actual pressures to predefined reference values. The control unit 302 processes error signals derived from these comparisons to adjust the pump speeds of the water circulation pumps 108, 126 accordingly, ensuring that pressures are regulated for efficient performance of the system 300, while remaining within safe operating limits. It may be noted that to protect the membrane 118, this pressure difference should not exceed the critical limit known as the membrane liquid entry pressure (LEP). The control scheme proposed is that the user will set the speed of the water circulation pumps 108, 126 to produce the desired pressure. Then the pressure sensors 306a, 306b are used to measure the actual pressures generated within the feed chamber 116 and the vapor chamber 120, respectively. The measured value from the pressure sensors 306a, 306b is compared with the reference pressure and the error signal is sent to the control unit 302. It may be understood that the pressure difference is not necessarily a fixed value. Sometimes a very high suction rate is required by the water ejector 122. In this case, a very low pressure is desired in the vapor chamber 120, which means the speed/flow rate of the water circulation pump 126 in the ejector module 104 (freshwater loop) will be very high. However, a very low pressure on one side will result in a higher-pressure difference, which could damage the membrane 118. For this reason, the pressure sensors 306a, 306b will notice if the pressure difference is close to the LEP and reduce the pressure on the feed side by controlling the speed of the water circulation pump 108 in the membrane module 102 (feed water loop) or simply shut off the system 300 for protection. Moreover, measuring and controlling the pressures (as mentioned) helps in setting the operating conditions of the system 300 based on the desired output. In addition, this control scheme can be used for matching the feed flow rate with the vacuum level required by the water ejector 122. Thirdly, the control unit 302 helps to maintain an adequate water level in the feed tank 106 for sustained operation. A level sensor 308 continuously monitors the water level, transmitting this data to the control unit 302. The control unit 302 compares the actual water level with the desired set point, adjusting the operation of the make-up supply 114 as needed to maintain operational levels. It may be appreciated that the water level management is needed during periods of high temperature or flow rates, as insufficient water can reduce vapor generation, affecting the efficiency of the system 300, and also potentially damage the water circulation pump 108. Thus, the comprehensive control scheme implemented by the control unit 302 in the system 300 enhances its operational efficiency.

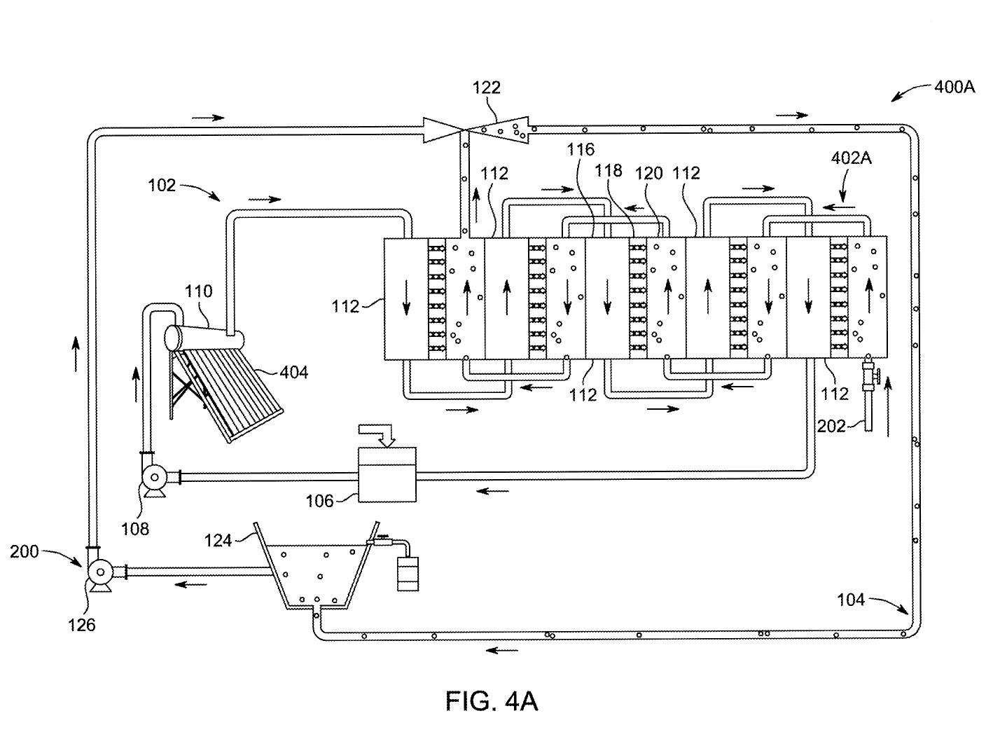

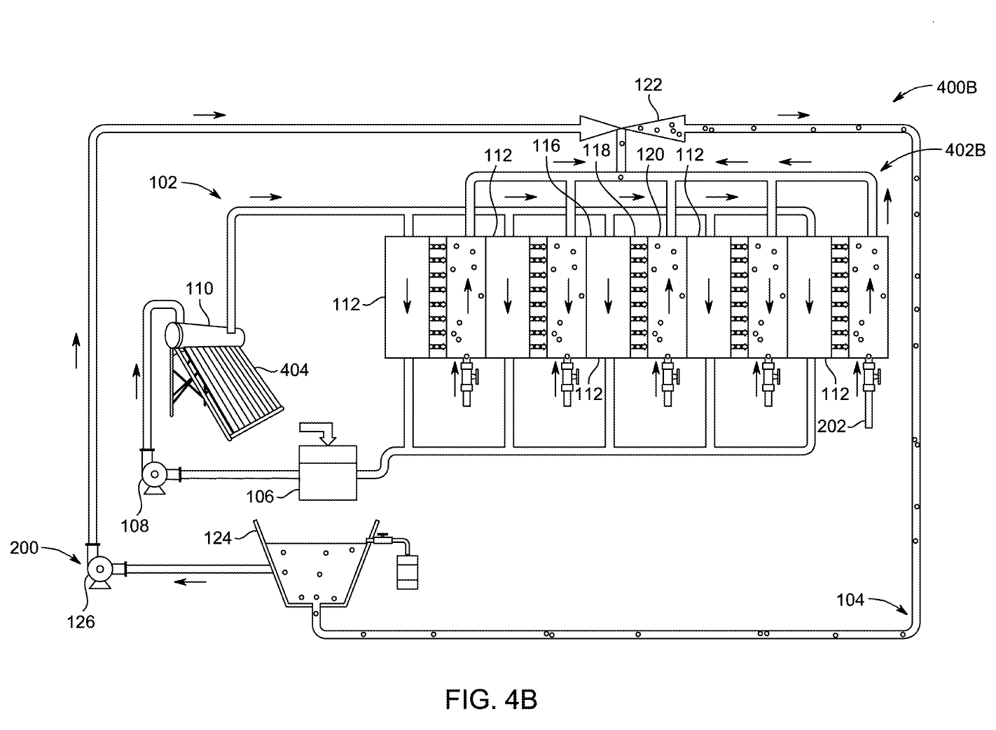

Referring now to FIG. 4A, illustrated is an exemplary schematic diagram of a system for desalinating water (represented by reference numeral 400A, and hereinafter referred to as “system 400A”), according to a fourth embodiment of the present disclosure. The system 400A is similar in configuration to the system 200 of FIG. 2, and includes a membrane distillation module 402A with a series of membrane distillation units 112 connected in series. Each membrane distillation unit 112 includes the feed chamber 116, the membrane 118, and the vapor chamber 120, as previously described. The feed chambers 116 of these membrane distillation unit 112 are sequentially connected, allowing salt water to pass through each membrane distillation unit 112 successively. Further, the vapor chambers 120 between the membrane distillation units 112 are interconnected to ensure a smooth transfer of vapor, maintaining an efficient and streamlined process of freshwater production throughout the series of membrane distillation units 112. Thus, the series arrangement of the membrane distillation units 112 improves the desalination process by facilitating sequential vaporization across multiple stages. This operational setup enables continuous operation wherein air is drawn from the atmosphere into the membrane distillation unit 112 at the first stage. As the air progresses through each subsequent stage, its temperature increases, enhancing its vapor content. This progression results in a gradual humidification process across the stages, resulting in the final stage where the vapor is mixed and condensed in the ejector module 104. Thus, the system 400A by systematically increasing the temperature of the air and thereby increasing its vapor content at each stage produces larger volumes of distilled freshwater.

Referring now to FIG. 4B, illustrated is an exemplary schematic diagram of a system for desalinating water (represented by reference numeral 400B, and hereinafter referred to as “system 400B”), according to a fifth embodiment of the present disclosure. The system 400B includes a membrane distillation module 402B with a series of membrane distillation units 112 connected in parallel. Each membrane distillation unit 112 includes the feed chamber 116, the membrane 118, and the vapor chamber 120, as previously described. In the system 400B, the membrane distillation units 112 are arranged in parallel configuration, allowing salt water to respectively pass through each unit. The feed chambers 116 of these membrane distillation units 112 receive salt water separately, ensuring parallel processing of multiple streams of salt water for desalination. Additionally, the vapor chambers 120 of the membrane distillation units 112 are interconnected to facilitate the transfer of vapor, maintaining an efficient process of freshwater production across the membrane distillation units 112. It may be understood that unlike the series configuration, where stages operate sequentially, the parallel arrangement in the system 400B allows for simultaneous processing of multiple salt water streams. Each membrane distillation unit 112 operates independently, processing salt water in its feed chamber 116 and facilitating vapor transfer through its interconnected vapor chamber 120. This configuration is recommended for the desired high flow rates of the feed water and sweeping air, making it suitable for applications requiring high-volume freshwater production with efficient use of space and resources.

The systems 400A and 400B, as illustrated in FIGS. 4A and 4B, respectively, includes a variable number of the corresponding membrane distillation units 112. In an embodiment, the systems 400A and 400B include 2 to 10, preferably 3 to 9, preferably 4 to 8, corresponding membrane distillation units 112. This flexibility in the number of membrane distillation units 112 allows for adaptability to different operational requirements and desired freshwater production capacities. In both configurations (series and parallel), the inclusion of multiple membrane distillation units 112 enhances the overall efficiency of the desalination process. By increasing the number of the membrane distillation units 112 available for vapor transport, the systems 400A, 400B can process a larger volume of salt water, leading to higher freshwater output. The specific number of the membrane distillation units 112 employed in the systems 400A, 400B can be determined based on various factors, including the desired freshwater production capacity, the available energy input, and the specific characteristics of the feed water.

Further, as illustrated in FIGS. 4A and 4B, the systems 400A and 400B incorporate the power source (as represented by reference numeral 404). The power source 404 provides energy to operate the water heater 110 within the membrane module 102. Specifically, the power source 404 is configured to supply electrical energy to the water heater 110. This ensures that the water heater 110 can consistently maintain operational heating conditions, for achieving efficient vaporization and subsequent water vapor transport across the membrane 118 of the membrane distillation unit 112. In present embodiments, the power source 404 is a renewable energy power source. In particular, the renewable energy power source 404 is solar power. Solar power harnesses energy from sunlight through photovoltaic panels or solar thermal collectors, converting it into electricity or heat. In some examples, the renewable energy power source 404 and the water heater 110 may be integrated as a solar water heater, without any limitations. In general, the utilization of the renewable energy source reduces reliance on non-renewable fossil fuels and reduces carbon footprint.

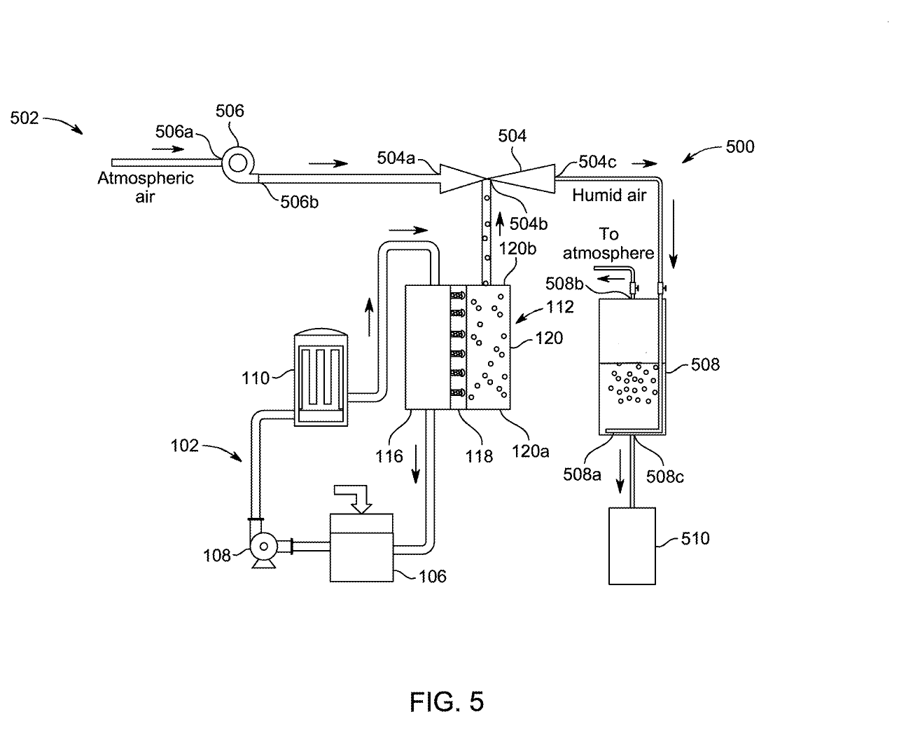

Referring now to FIG. 5, illustrated is an exemplary schematic of a system for desalinating water (represented by reference numeral 500, and hereinafter referred to as “system 500”), according to a sixth embodiment of the present disclosure. The system 500 is similar to the system 100 of FIG. 1 in configuration with the membrane module 102, however, instead of a water ejector, the system 500 includes an ejector module 502 utilizing an air ejector 504. That is, the membrane module 102 includes the feed tank 106; the water circulation pump 108; the water heater 110; the membrane distillation unit 112; and the power source. Further, the membrane distillation unit 112 includes, in order, the feed chamber 116, the membrane 118, and the vapor chamber 120. The other details related to the membrane module 102, as discussed in reference to the system 100 of FIG. 1 (or the system 200 of FIG. 2), applies to the membrane module 102 of the system 500, and thus are not repeated herein for brevity of the present disclosure. In the system 500, the vapor passes from the feed chamber 116 through the membrane 118 to the vapor chamber 120. Herein, the second side 120b of the vapor chamber 120 is operationally connected to the air ejector 504 of the ejector module 502.

In particular, the ejector module 502, in addition to the air ejector 504, includes an air blower 506 and a bubble column dehumidifier (BCD) module 508. Herein, an inlet 506a of the air blower 506 is configured to receive air. An outlet 506b of the air blower 506 is operationally connected to a first inlet 504a of the air ejector 504. Also, the second side 120b of the vapor chamber 120 is operationally connected to a second inlet 504b the air ejector 504. An outlet 504c of the air ejector 504 is operationally connected to an inlet 508a of the BCD module 508. The air blower 506 is a device that provides a high-velocity mainstream of air to the air ejector 504. As this high-velocity air passes through the converging-diverging nozzle of the air ejector 504, it creates a low-pressure zone at the throat, generating a vacuum effect. This vacuum draws in the humid air (a secondary stream) from the vapor chamber 120 of the membrane distillation unit 112 into the air ejector 504. The two air streams mix within the air ejector 504, and the resulting humid air stream is then directed to the BCD module 508. The BCD module 508 is configured to remove water vapor from the humid air stream. The dehumidified air exiting the BCD module 508 can be released into the atmosphere via a vapor outlet 508b, or, in a closed-loop configuration, recirculated back to the air blower 506. More specifically, in the system 500, the air is pumped through the ejector module 502 to the outlet 504c of the air ejector 504. The vapor is mixed with the air pumped through the ejector module 502 in the air ejector 504 to form humid air. The BCD module 508 is configured to capture a portion of the vapor in the humid air to form desalinated water. The BCD module 508 includes a desalinated water outlet 508c operationally connected to a desalinated water tank 510 to collect the desalinated water.

It may be appreciated that the BCD module 508 does not include any active cooling mechanism, and instead relies on natural convection for cooling its surface with a multi-effect process. In this regard, the BCD module 508 may be constructed using surface materials of higher thermal conductivity, such as metals, to facilitate efficient heat dissipation. Further, the heat dissipation from the BCD module 508 may be improved by increasing the area of heat transfer. For instance, the BCD module 508 may include fins (not shown), as extended surfaces, on the outer surface to increase the area of heat transfer, hence better cooling/condensation is achieved.

Similar to the system 100, 200, the membrane 118 is a hydrophobic microporous membrane. The hydrophobic microporous membrane 118 with its hydrophobic nature repels water molecules while allowing water vapor to pass through, thereby facilitating the separation of fresh water from salt water. Further, the microporous structure of the hydrophobic microporous membrane 118 consists of small pores that selectively permit the passage of water vapor molecules, effectively filtering out dissolved salts and other impurities present in the feed salt water. This combination of hydrophobicity and microporosity enables the membrane 118 to maintain high separation efficiency and durability over extended operational periods within the membrane distillation unit 112.

Further, in present embodiments, the system 500 may not include a vacuum pump. That is, the system 500 is designed to operate without a vacuum pump, a component typically found in conventional desalination systems. Instead of relying on a vacuum pump to create the necessary vacuum, the system 500 utilizes the air ejector 504. The air ejector 504, driven by the air blower 506, harnesses the Venturi effect to generate a vacuum within the system 500. This vacuum is sufficient to draw water vapor from the membrane distillation unit 112, facilitating the desalination process. By eliminating the need for a vacuum pump, the system 500 reduces energy consumption, operational costs, and system complexity, while maintaining effective desalination capabilities.

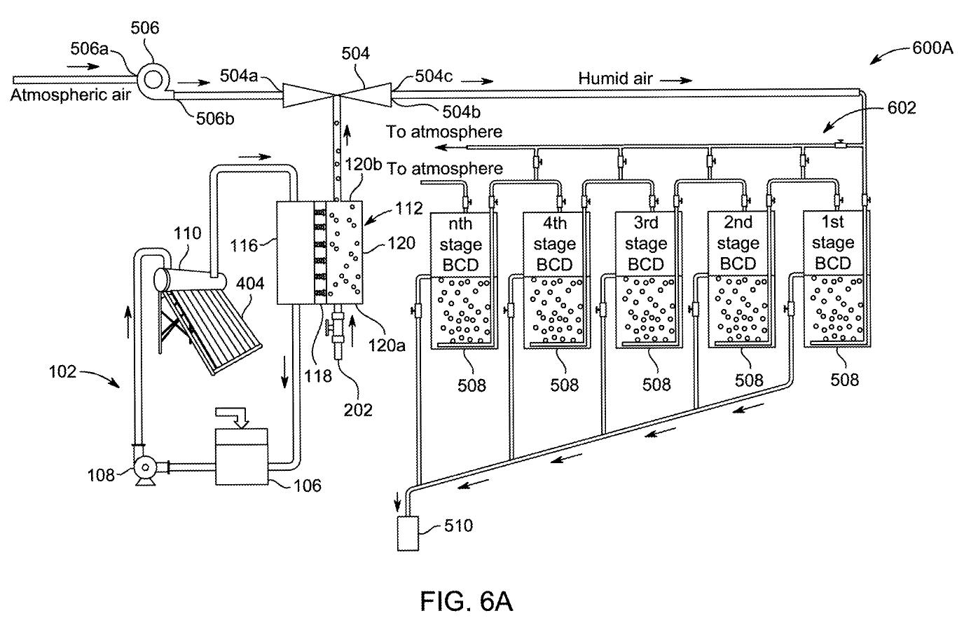

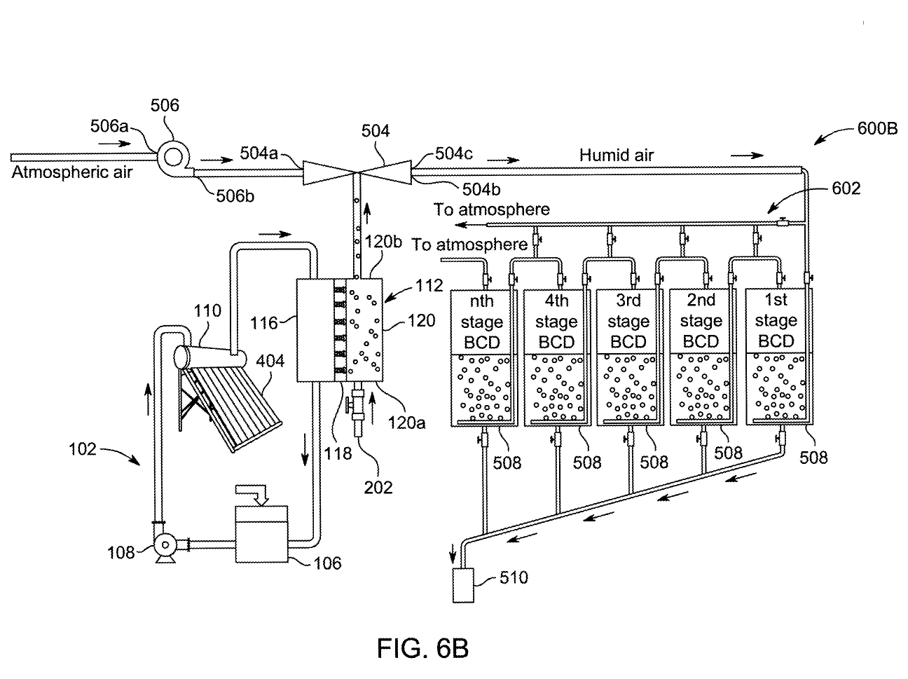

Referring now to FIG. 6A, illustrated is an exemplary schematic of a system for desalinating water (represented by reference numeral 600A, and hereinafter referred to as “system 600A”), according to a seventh embodiment of the present disclosure. The system 600A is similar to the system 500 of FIG. 5 in configuration, however the BCD module herein is a multi-stage BCD module (as represented by reference numeral 602). Similarly, referring to FIG. 6B, illustrated is an exemplary schematic of a system for desalinating water (represented by reference numeral 600B, and hereinafter referred to as “system 600B”), according to an eighth embodiment of the present disclosure. The system 600B is similar to the system 500 of FIG. 5 in configuration, however the BCD module herein also is the multi-stage BCD module 602. In the system 600A, 600B, the multi-stage BCD module 602 comprises n number of stages, with each stage containing a bubble column, which is equivalent to the BCD module 508 and hereinafter referred to as the bubble column 508. Herein, n is an integer from 1-100, preferably 5 to 80, preferably 10 to 50. That is, the number of stages in the multi-stage BCD module 602 ranges from 1-100, preferably 5 to 80, preferably 10 to 50.

In the multi-stage BCD modules 602 of each of the systems 600A, 600B, a first stage is operationally connected to the outlet 504c of the air ejector 504 to allow travel of the humid air and is configured to capture a portion of the vapor in the humid air to form desalinated water. Each bubble column 508 includes the vapor outlet 508b through which a portion of the vapor that is not captured in the one stage is configured to pass to a next stage. The humid air from the air ejector 504 enters the first stage of the multi-stage BCD module 602 and flows sequentially through each subsequent stage. In each stage, a portion of the water vapor present in the humid air condenses and is collected as desalinated water. The remaining air, with reduced humidity, then proceeds to the next stage. This sequential arrangement of multiple stages in the multi-stage BCD module 602 allows for a more thorough dehumidification process compared to a single-stage BCD module. As the humid air travels through each stage, the gradual reduction in humidity and temperature enhances the overall efficiency of water vapor condensation and collection. The desalinated water outlets 508c of each stage are connected to the desalinated water tank 510, where the collected freshwater from all stages is accumulated. The multi-stage BCD module 602 in the system 600A, 600B, thus, improves the recovery of freshwater from the humid air stream, contributing to the overall efficiency and productivity of the desalination process.

In the system 600A, as depicted in FIG. 6A, the desalinated water produced in each stage of the multi-stage BCD module 602 is collected through a distinct mechanism. As the desalinated water accumulates within each stage and reaches a predetermined level, it is automatically drained through a collection line equipped with a controlled valve. This valve, positioned at the specified water level, opens to allow the collected desalinated water to flow out of the stage and into the desalinated water tank 510. The controlled valve ensures that the water level within each stage remains within the desired range, preventing overflow and maintaining operating conditions. In the system 600B, as depicted in FIG. 6B, the collection of desalinated water from the multi-stage BCD module 602 follows a different approach. Instead of collection based on water level, the system 600B employs a timed collection mechanism. A collection line with a controlled valve is installed at the bottom of each stage of the multi-stage BCD module 602. This valve is programmed to open at specific intervals, allowing the accumulated desalinated water to drain from each stage into the desalinated water tank 510. The timed collection approach offers flexibility in managing the water collection process and can be adjusted based on the desired frequency and volume of water collection. It may be noted that in both systems 600A, 600B, gravity facilitates the collection of desalinated water. The collection lines and the desalinated water tank 510 are positioned at a lower elevation than the multi-stage BCD module 602, allowing the desalinated water to flow naturally under the force of gravity. This gravity-assisted collection mechanism eliminates the need for additional pumps or energy-intensive processes, contributing to the overall energy efficiency of the systems 600A, 600B.

Further, as illustrated in FIGS. 6A and 6B, the systems 600A and 600B incorporate the power source (as represented by reference numeral 404). The power source 404 provides the necessary energy to operate the water heater 110 within the membrane module 102. Specifically, the power source 404 is configured to supply electrical energy to the water heater 110. This ensures that the water heater 110 can consistently maintain operational heating conditions, for achieving efficient vaporization and subsequent water vapor transport across the membrane 118 of the membrane distillation unit 112. In present embodiments, the power source 404 is a renewable energy power source. In particular, the renewable energy power source 404 is solar power. Solar power harnesses energy from sunlight through photovoltaic panels or solar thermal collectors, converting it into electricity or heat. In some examples, the renewable energy power source 404 and the water heater 110 may be integrated as a solar water heater, without any limitations. In general, the utilization of the renewable energy source reduces reliance on non-renewable fossil fuels and reduces carbon footprint.

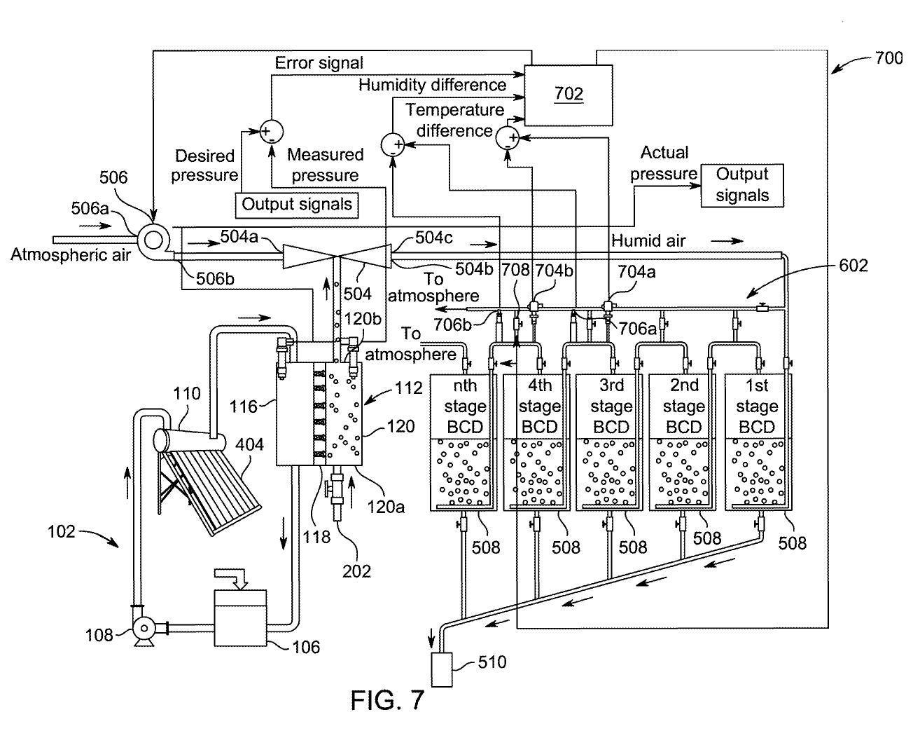

Referring to FIG. 7, illustrated is an exemplary schematic of a system for desalinating water (represented by reference numeral 700, and hereinafter referred to as “system 700”), according to a ninth embodiment of the present disclosure. The system 700 is similar to the system 600B of FIG. 6B in configuration, and additionally incorporates a control unit 702. The control unit 702 is configured to manage various aspects of operation of the system 700, ensuring operational conditions for efficient performance of the system 700. In particular, herein, the control unit 702 controls at least one selected from the group consisting of a temperature between the n number of stages and a humidity between the n number of stages. That is, the control unit 702 is configured to monitor and regulate the temperature and humidity levels between the multiple stages of the multi-stage BCD module 602. To achieve this, the control unit 702 receives input signals from temperature sensors 704a and 704b, and humidity sensors 706a and 706b strategically positioned at the outlet of each stage (only shown with two exemplary stages). These sensors continuously measure the temperature and humidity of the air exiting each stage, providing real-time data to the control unit 702. The control unit 702 then compares these measured values with predetermined setpoints for temperature and humidity. If the measured values deviate from the setpoints, the control unit 702 generates error signals, which are then used to adjust the operational parameters of the system 700.

Specifically, herein, the air blower 506, similar to the variable speed pumps in the system 200, is controlled based on pressure measurements from sensors in the feed and vapor chambers of the membrane distillation units 112. This control mechanism ensures operational air flow rate for efficient vacuum generation and vapor extraction. Additionally, the control unit 702 controls the multi-stage BCD module 602. In the absence of this control, the humid air would pass through all stages of the multi-stage BCD module 602, undergoing cooling and dehumidification, before being released into the atmosphere. However, the control unit 702 improves this process. Temperature and humidity sensors 704a, 704b, 706a, and 706b are strategically placed at the outlet of each stage of the multi-stage BCD module 602. These sensors monitor the state of the air as it exits each stage. The control unit 702 analyzes the data from these sensors, for example focusing on the drop in air temperature and humidity between consecutive stages. If this drop falls below a predetermined threshold, it indicates that further dehumidification in subsequent stages would be negligible. Consequently, the control unit 702 identifies the stage where the drop is below the threshold as the last effective stage and redirects the air from this stage directly to the atmosphere via a control valve 708 (as shown), or to a closed-loop recirculation path. This control scheme improves the dehumidification process by utilizing only the necessary number of stages of the multi-stage BCD module 602. By bypassing unnecessary stages, the system 700 reduces the pumping power required for both air and water streams, as it eliminates the need to overcome static heads and frictional losses in unused stages. This reduction in pumping power translates to lower operational costs and improved energy efficiency for the system 700.

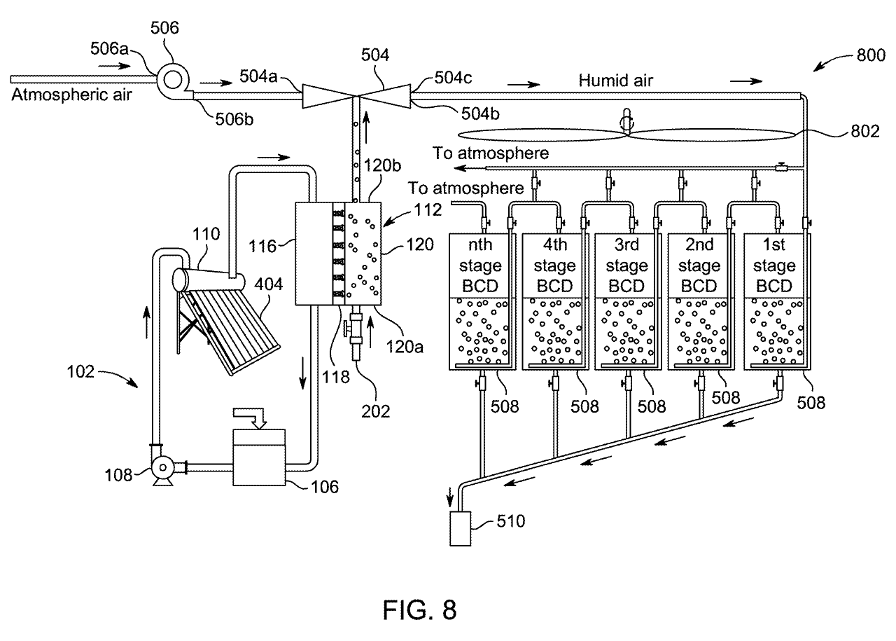

Referring to FIG. 8, illustrated is an exemplary schematic of a system for desalinating water (represented by reference numeral 800, and hereinafter referred to as “system 800”), according to a tenth embodiment of the present disclosure. The system 800 is similar to the system 600B of FIG. 6B in configuration, and additionally incorporates a fan 802. The fan 802 is disposed adjacent to the multi-stage BCD module 602 (or, in general, adjacent to the BCD module 508). The fan 802 is configured to enhance the cooling of the multi-stage BCD module 602, thereby improving its dehumidification efficiency. The fan 802 is strategically positioned adjacent to the multi-stage BCD module 602 to direct a flow of air over the external surfaces of the bubble columns 508 within the multi-stage BCD module 602. This forced air cooling facilitates heat dissipation from the multi-stage BCD module 602, promoting condensation of water vapor from the humid air stream. By enhancing the cooling process, the fan 802 increases the rate of vapor condensation, leading to a higher yield of desalinated water. The integration of the fan 802 in the system 800 improves the performance of the multi-stage BCD module 602, making the desalination process more efficient and productive.

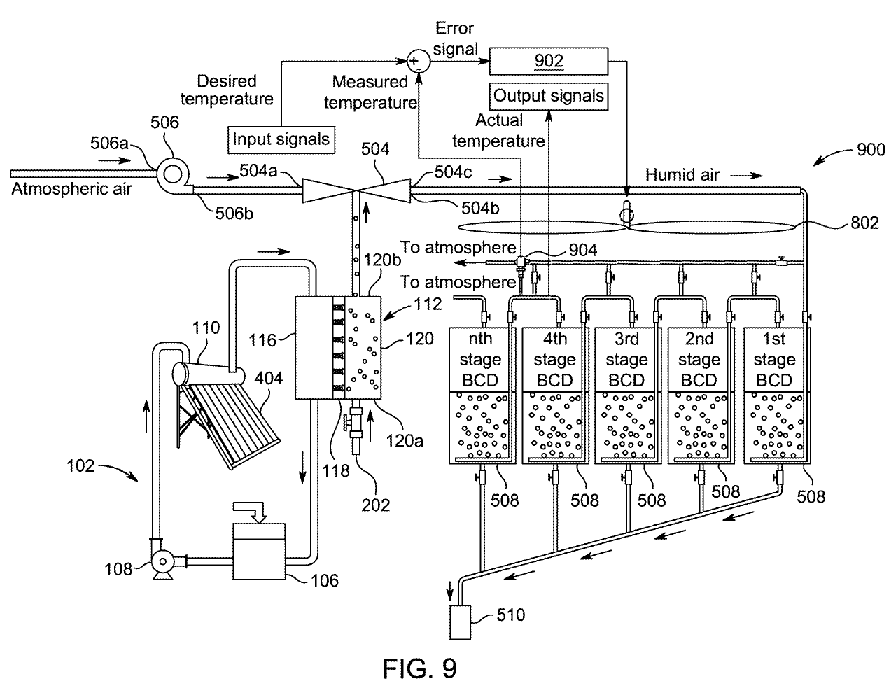

Referring to FIG. 9, illustrated is an exemplary schematic of a system for desalinating water (represented by reference numeral 900, and hereinafter referred to as “system 900”), according to an eleventh embodiment of the present disclosure. The system 900 is similar to the system 800 of FIG. 8 in configuration, and additionally includes a control unit 902. The control unit 902 is configured to regulate the speed of the fan 802 based on the temperature of the air exiting the multi-stage BCD module 602. The control unit 902 receives input signals from a temperature sensor 904, which is positioned at outlet of at least one of stages of the multi-stage BCD module 602. The control unit 902 compares the measured temperature to a desired temperature setpoint and generates an error signal. This error signal is then used to adjust the speed of the fan 802, ensuring that the air exiting the multi-stage BCD module 602 is at the desired temperature. By controlling the speed of the fan 802, the control unit 902 can improve the cooling of the multi-stage BCD module 602 and improve its dehumidification efficiency, thus enhancing the overall efficiency of the system 900.

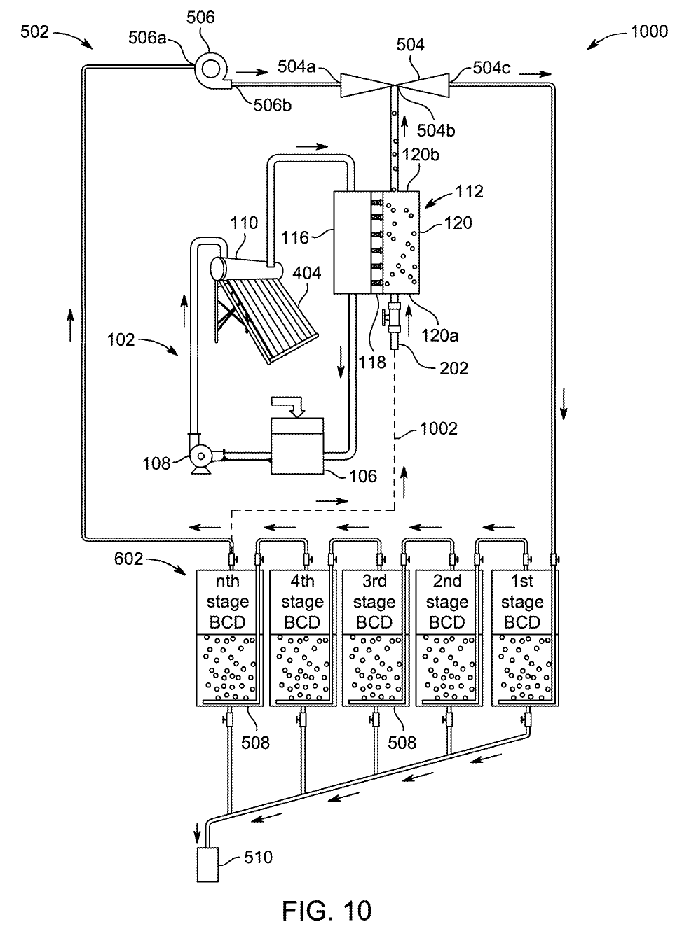

Referring to FIG. 10, illustrated is an exemplary schematic of a system for desalinating water (represented by reference numeral 1000, and hereinafter referred to as “system 1000”), according to a twelfth embodiment of the present disclosure. The system 1000 is similar to the system 600B of FIG. 6B in configuration, and additionally includes the air inlet 202 and implements a closed air cycle. As discussed, the presence of the pressure valve 203 allows for the adjustment of pressure within the vapor chamber 120 of the membrane distillation unit 112. Specifically, the air inlet 202 is configured to create a pressure differential across the membrane 118 located within the membrane distillation unit 112. This pressure differential gradient aids in the facilitation of water vapor transport through the membrane 118. In the system 1000, the air blower 506 takes the vapor outlet 508b from the last stage of the multi-stage BCD module 602 to the air inlet 202 by a line 1002 (as depicted by dashed lines), to be delivered to the air ejector 504. Thus, the air cycle is now closed, and the air is acting as the working fluid vapor carrier. Circulating the air in a closed cycle makes the system 1000 independent of the environmental change of air humidity and impurities. In this configuration, the power consumption of the system 1000 is only for the air blower 506 and the water circulation pump 108, and both require relatively low power for operation. It is also worth mentioning that, using the renewable energy power source 404 to drive the air blower 506 and the water circulation pump 108 will reduce the power required for the system 1000, as clean energy utilization.

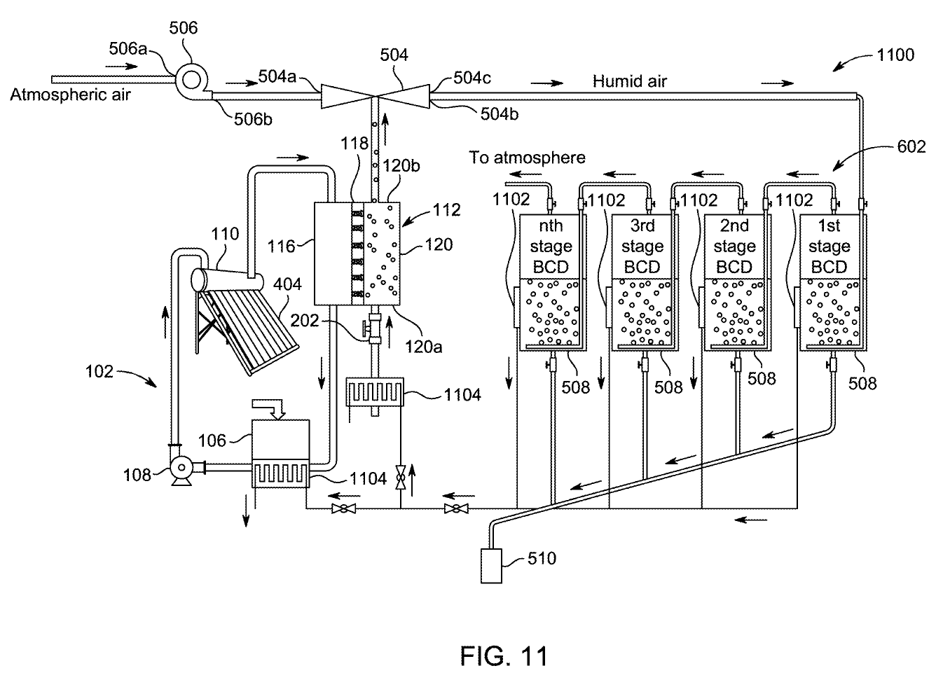

Referring to FIG. 11, illustrated is an exemplary schematic of a system for desalinating water (represented by reference numeral 1100, and hereinafter referred to as “system 1100”), according to a thirteenth embodiment of the present disclosure. The system 1100 is similar to the system 600B of FIG. 6B in configuration, and additionally includes n number of thermoelectric coolers (TECs) 1102 and a heat exchanger 1104. Each of the TECs 1102 is disposed adjacent to the corresponding bubble column 508 in the multi-stage BCD module 602. In an embodiment, the number of the TECs 1102 in the system 1100 is equal to the number of the bubble columns 508 in the multi-stage BCD module 602. The TECs 1102 are solid-state heat pumps that use the Peltier effect to transfer heat from one side of the device to the other. In the system 1100, the TECs 1102 are configured to cool the outer surfaces of the bubble columns 508, thereby improving the dehumidification efficiency of the multi-stage BCD module 602. The power needed to operate the TECs 1102 may be provided by the renewable energy power source 404. By cooling the bubble columns 508, the TECs 1102 promote condensation of water vapor from the humid air stream. The heat dissipated from the TECs 1102 during the cooling process is not wasted; instead, it is channeled to the heat exchanger 1104. The heat exchanger 1104 utilizes this recovered heat to pre-heat the feed water in the feed tank 106 or the air entering the membrane distillation unit 112 through the air inlet 202. The selection of which fluid to pre-heat depends on the temperature difference between the hot air from the TECs 1102 and the target fluid. Pre-heating the feed water or inlet air can enhance the overall efficiency of the desalination process. For instance, pre-heating the inlet air increases its ability to carry more moisture and hence increases productivity of the system 1100. Thus, the integration of the TECs 1102 and the heat exchanger 1104 in the system 1100 improves the performance of the multi-stage BCD module 602 and contributes to energy conservation by utilizing waste heat for pre-heating purposes.

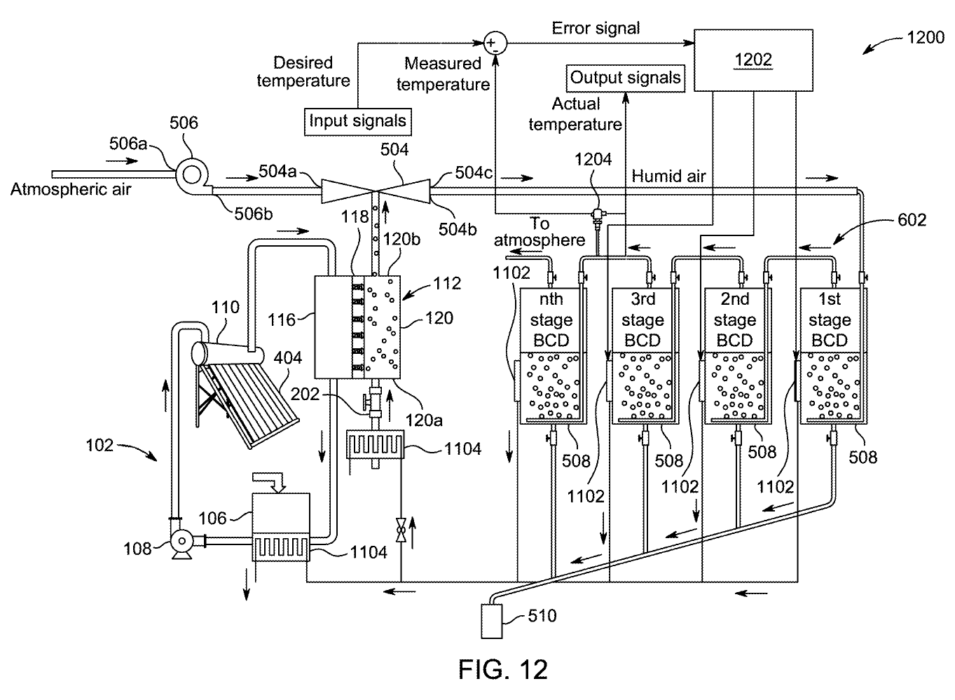

Referring to FIG. 12, illustrated is an exemplary schematic of a system for desalinating water (represented by reference numeral 1200, and hereinafter referred to as “system 1200”), according to a fourteenth embodiment of the present disclosure. The system 1200 is similar to the system 1100 of FIG. 11 in configuration, and additionally includes a control unit 1202. The control unit 1202 is configured to regulate the power input to each TEC 1102 based on the temperature of the air exiting the corresponding bubble column 508 in the multi-stage BCD module 602. The control unit 1202 receives input signals from a temperature sensor 1204 positioned at an outlet of the bubble column 508 of the second-last stage in the multi-stage BCD module 602. The control unit 1202 compares the measured temperature to a desired temperature setpoint and generates an error signal. This error signal is then used to adjust the power input to the corresponding TEC 1102, ensuring that the air exiting each bubble column 508 is at the desired temperature. By controlling the power input to the TECs 1102, the control unit 1202 can improve the cooling of each bubble column 508 and improve the overall dehumidification efficiency of the multi-stage BCD module 602, thus enhancing the overall efficiency of the system 1200.

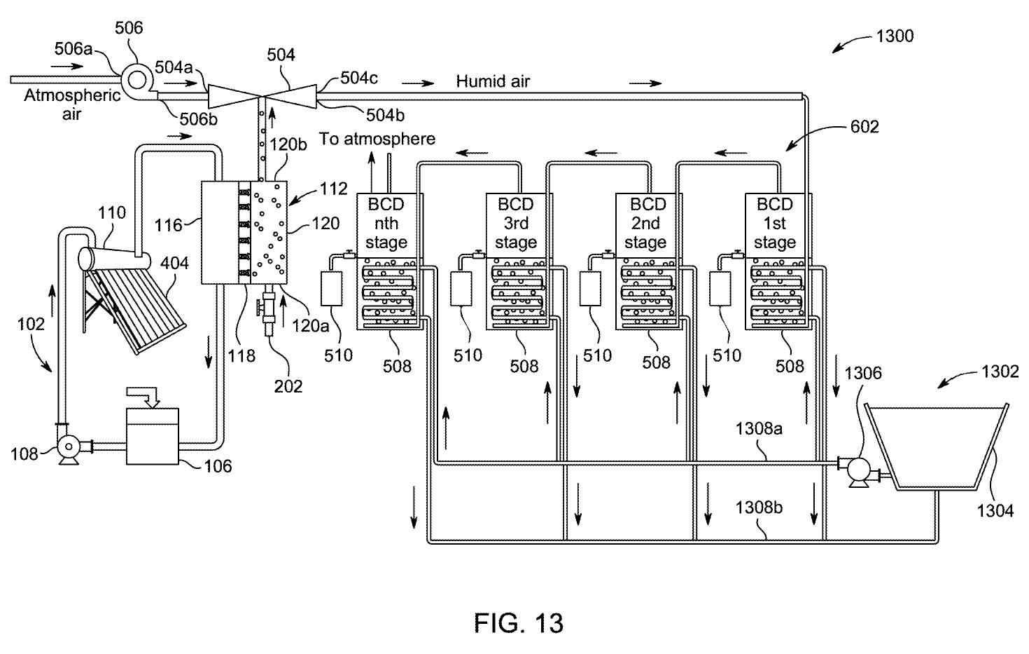

Referring to FIG. 13, illustrated is an exemplary schematic of a system for desalinating water (represented by reference numeral 1300, and hereinafter referred to as “system 1300”), according to a fifteenth embodiment of the present disclosure. The system 1300 is similar to the system 600B of FIG. 6B in configuration, and additionally includes a water cooling system 1302. Herein, the water cooling system 1302 provides a circulating chilled water flow to each bubble column 508. In particular, as shown, the water cooling system 1302 includes a water source 1304 at an environmental temperature, such as sea water, or any relatively large coolant reservoir to have a constant supply temperature of the cooling water. A centrifugal pump 1306 is operatively connected to the water source 1304, and an inlet of each of the bubble column 508 in the multi-stage BCD module 602 via an inlet line 1308a. The centrifugal pump 1306 is configured to pump water to the bubble columns 508. Further, each of the bubble column 508 has an outlet, operatively connected to a return line 1308b to the water source 1304, to return the cooling water. Thus, the cooling of the bubble columns 508 in the multi-stage BCD module 602 is achieved for free energy, except for the small pumping energy to be used by centrifugal pump 1306. The cooling water is delivered to all bubble columns 508 in a parallel manner for better cooling.

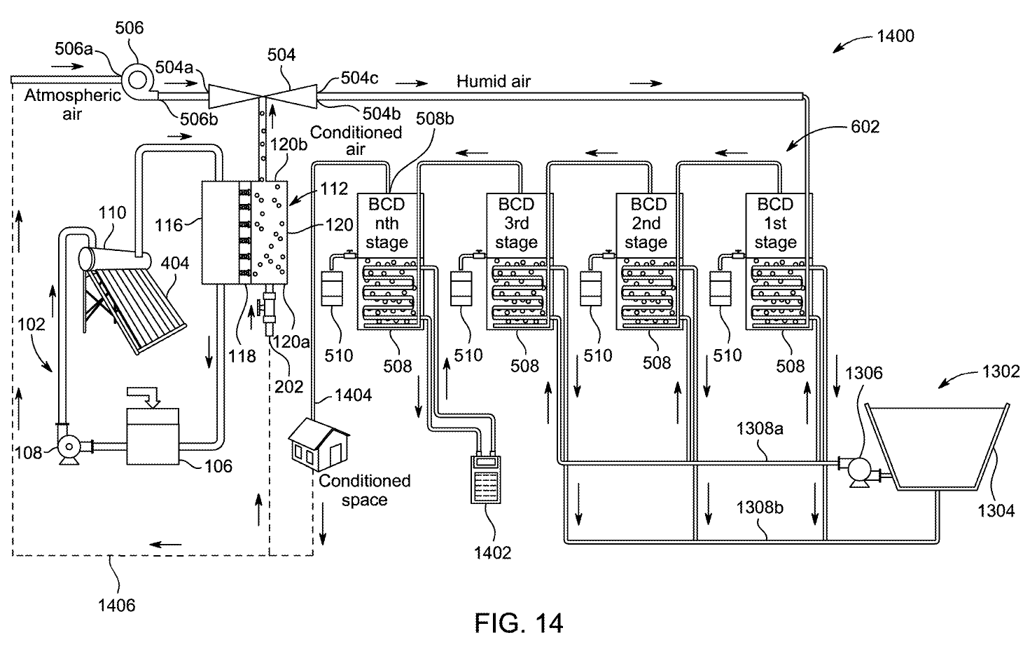

Referring to FIG. 14, illustrated is an exemplary schematic of a system for desalinating water (represented by reference numeral 1400, and hereinafter referred to as “system 1400”), according to a sixteenth embodiment of the present disclosure. The system 1400 is similar to the system 1300 of FIG. 13 in configuration, and additionally includes a water chiller 1402. The water chiller 1402 is operatively connected to the final stage of the multi-stage BCD module 602, and is configured to provide chilled water to the final bubble column 508 therein. The remaining stages of the multi-stage BCD module 602 are cooled by the water cooling system 1302, as discussed previously. The chilled water from the water chiller 1402 cools the final stage of the multi-stage BCD module 602 to a lower temperature than the other stages, which enhances the dehumidification process and improves vapor extraction. The air leaving the final stage of the multi-stage BCD module 602 is then used for space cooling/air conditioning applications through a line 1404 (as shown). In a further embodiment, as illustrated in FIG. 14, the vapor outlet 508b of the bubble column 508 of the final stage of the multi-stage BCD module 602 is operationally connected to the inlet 506a of the air blower 506, thereby creating a closed system. That is, the air used for space cooling may be recirculated to the air blower 506 through a line 1406, thereby creating a closed air cycle. The use of environmental water cooling for all but the final stage of the multi-stage BCD module 602 reduces the energy consumption of the system 1400, while the use of chilled water cooling for the final stage improves vapor extraction and provides cool air for space cooling. It may be noted that the air temperature is reduced significantly with almost no energy consumption through the stages cooled by the environmental water. Hence, the power consumption of the water chiller 1402 is very low, and on the other side, the productivity is high. It is also worth mentioning that the air coming out of the final stage has approximately the same temperature as the water inside this stage. Based on previous studies, the effectiveness of the bubble columns 508 is more than 90%. Therefore, the output air may be used for air conditioning of buildings, without adversely affecting the distillation performance (for desalinating water) of the system 1400.

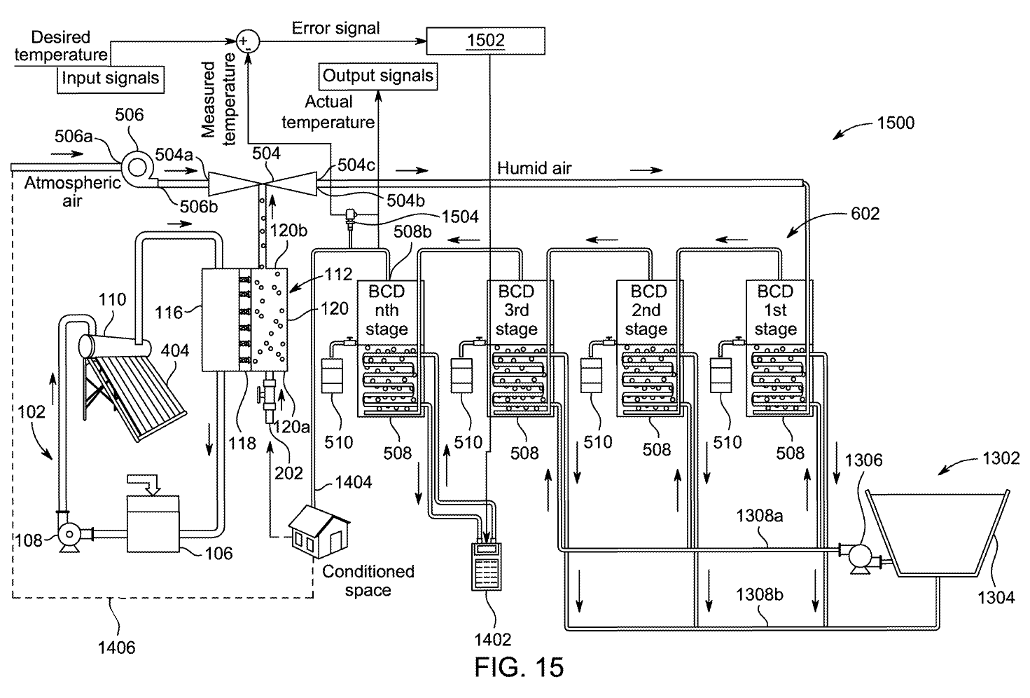

Referring to FIG. 15, illustrated is an exemplary schematic of a system for desalinating water (represented by reference numeral 1500, and hereinafter referred to as “system 1500”), according to a seventeenth embodiment of the present disclosure. The system 1500 is similar to the system 1400 of FIG. 14 in configuration, and additionally includes a control unit 1502. The control unit 1502 is configured to manage the quality of the air, in terms of temperature and humidity, being delivered to the occupants within the space. The control unit 1502 receives input signals from a temperature sensor 1504, which is positioned at the outlet of at least the last stage of the multi-stage BCD module 602. The control unit 1502 compares the measured temperature to a desired temperature setpoint and generates an error signal. This error signal is then used to adjust the degree of cooling provided by the water chiller 1402, ensuring that the air exiting the multi-stage BCD module 602 and entering the space is at the desired temperature. As may be contemplated, the control unit 1502, in this configuration, broadly acts as a thermostat. By controlling the water chiller 1402, the control unit 1502 can improve the cooling and dehumidification of the air, thus enhancing the overall efficiency of the system 1500.

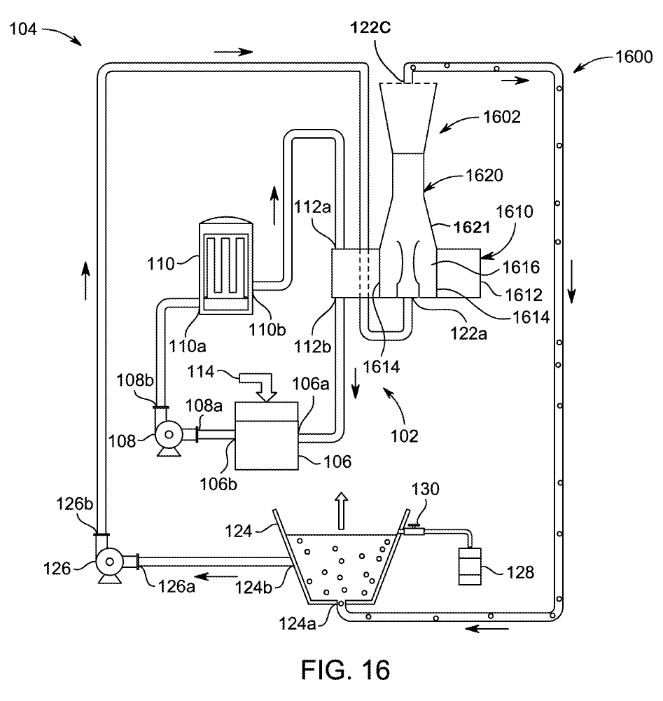

Referring to FIG. 16, illustrated is an exemplary schematic of a system for desalinating water (represented by reference numeral 1600, and hereinafter referred to as “system 1600”), according to an eighteenth embodiment of the present disclosure. The system 1600 is similar to the system 100 of FIG. 1 in configuration. That is, the embodiment of the system 1600 is similar to the embodiment of the system 100. Similar or identical components are labeled with similar or identical numerals unless specified otherwise. Descriptions have been provided above and will be omitted for simplicity purposes.

Instead of including the membrane distillation unit 112 and the water ejector 122 as two units as shown in FIG. 1, the system 1600 has a single integrated unit referred to as a distillation-ejector module 1602. The distillation-ejector module 1602 is configured to integrate the membrane distillation and ejector functions into a single compact unit. As illustrated, the distillation-ejector module 1602 includes a distillation portion 1610 and an ejector portion 1620. The distillation portion 1610 includes a feed chamber 1612, a membrane 1614 and a vapor chamber 1616. The feed chamber 1612 is operationally connected to the outlet 110b of the water heater 110 via the inlet 112a as well as operationally connected to the inlet 106a of the feed tank 106 via the first outlet 112b.

The membrane 1614 is a hydrophobic microporous membrane that is similar to the membrane 118 and repels water molecules while allowing water vapor to pass through. The membrane 1614 forms a suction chamber of the ejector portion 1620. That is, a primary fluid stream (e.g. water exiting from the outlet 126b of the water circulation pump 126 entering the first inlet 122a) accelerates in the ejector portion 1620, and a vacuum can be created in the vapor chamber 1616. As a result, a pressure differential can be created or enlarged across the membrane 1614 between the feed chamber 1612 and the vapor chamber 1616 so that the water vapor is sucked from the feed chamber 1612 across the membrane 1614 to the vapor chamber 1616 as a secondary fluid stream. The primary fluid stream and the secondary fluid stream can mix in the ejector portion 1620 and exit the outlet 122c of the ejector portion 1620 as a mixed stream containing the water vapor.

In an example, the feed chamber 1612 and the membrane 1614 can be arranged as two concentric cylinders. Unlike the system 100 of FIG. 1, the system 1600 does not require a separate vapor chamber (e.g. 120), as the membrane 1614 itself acts as the interface between the feed water and the ejector suction. This configuration allows for direct vapor extraction through the membrane 1614 into the ejector portion 1620. The integration of the distillation and ejector functions in the distillation-ejector module 1602 can lead to a more compact system design and potentially improved efficiency in the vapor extraction process. Additionally, an exterior portion 1621 of the ejector portion 1620 adjacent to the membrane 1614 includes a different material from the membrane 1614. For instance, the exterior portion 1621 is not selectively permeable and is instead configured to contain and confine the primary fluid stream, the secondary fluid stream and the mixed stream.

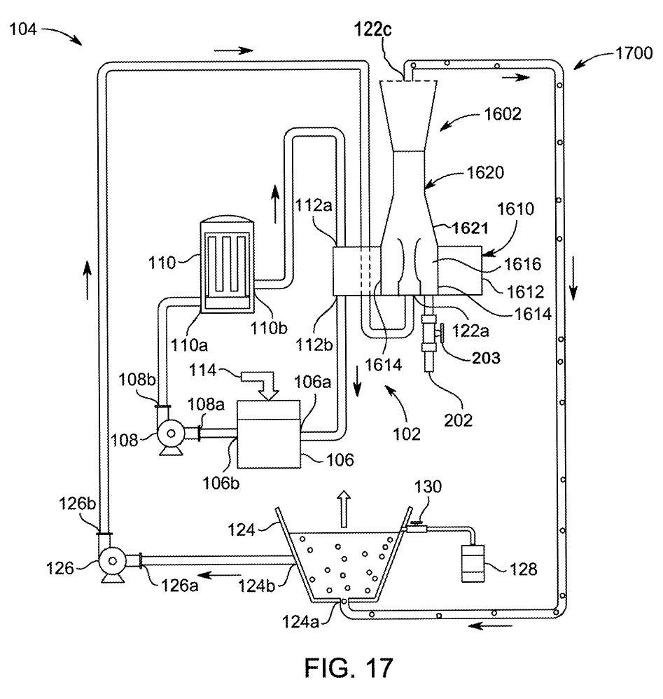

Referring to FIG. 17, illustrated is an exemplary schematic of a system for desalinating water (represented by reference numeral 1700, and hereinafter referred to as “system 1700”), according to a nineteenth embodiment of the present disclosure. The system 1700 is similar to the system 1600 of FIG. 16 and the system 200 of FIG. 2 in configuration. That is, the embodiment of the system 1700 is similar to the embodiment of the system 1600 and the embodiment of the system 200. Similar or identical components are labeled with similar or identical numerals unless specified otherwise. Descriptions have been provided above and will be omitted for simplicity purposes.

The system 1700 includes the air inlet 202 and the pressure valve 203. The air inlet 202 is positioned to allow atmospheric air to enter the distillation-ejector module 1602. The pressure valve 203 is configured to regulate the flow of air through the air inlet 202. This configuration allows for adjustment of the pressure differential across the membrane within the distillation-ejector module 1602. By controlling the air flow through the pressure valve 203, the system 1700 can adjust the vapor extraction process and potentially enhance the overall desalination efficiency.

The present disclosure provides the system 100 (and its various alternate embodiments) for desalinating water that offers significant advantages over prior art. The integration of the membrane distillation unit 112 of the membrane module 102 with the ejector module 104 (utilizing the water ejector 122 or the air ejector 504) results in a flux-enhanced, low-energy-consumption, compact, multistage water desalination system. This design eliminates the need for a conventional vacuum pump, reducing energy consumption and operational costs. The system 100 is versatile, accommodating various MD module configurations (VMD or SGMD) and ejector operation modes (water or air), making it adaptable to different operational requirements and feed water conditions.

It may be appreciated that one practical solution to create a vacuum is to use an ejector. Ejectors are usually used in the thermal vapor compression cycle for the single-effect evaporation processes. The principle of ejector is to pass a fluid (e.g. a gas or a liquid) through a convergent-divergent duct. The fluid accelerates in the converging section of the ejector to a maximum velocity at a throat 122d, which results in a local minimum pressure, creating a vacuum to suck the other fluid to the mixing section where the high-velocity working fluid mixes with the fluid drawn in by the vacuum, imparting enough velocity to be ejected. The ejector cross-section then gradually expands to decrease the velocity of the ejected stream, allowing the pressure to increase to the outlet pressure. The strength of the vacuum produced depends on the velocity and shape of the fluid jet created for suction, as well as the shape of the constriction and mixing sections. The ejector has a lot of merits as compared to the vacuum pump. For example, an ejector does not have mechanical moving parts, is available in the market, and has a low cost of maintenance. Furthermore, an ejector has a low operating cost as it consumes no input power. Moreover, it is reliable for operation for a long time and can handle humid air with no problems.

The present disclosure addresses the limitations of prior art by providing a more efficient and reliable method for water desalination. Unlike conventional systems that rely on energy-intensive vacuum pumps, the present disclosure utilizes an ejector (e.g. the water ejector 122 or the air ejector 504) to create the vacuum effect, reducing energy consumption and operational costs. The incorporation of the control scheme further enhances performance of the system 100 by improving operating conditions, protecting the membrane 118 from damage, and improving freshwater production. The control scheme monitors and adjusts various parameters, such as pressure, temperature, and flow rates, in real-time, ensuring efficient and safe operation.

Additionally, the present disclosure offers flexibility in system design and operation. The membrane module 102 can be configured as a VMD or SGMD system, and the ejector module 104 can be operated using fresh water or air. The system 100 can also be designed with single or multistage membrane modules, multistage dehumidifiers, and open or closed air stream loops, providing adaptability to different operational requirements and desired freshwater production capacities. In addition to the production of freshwater, the present system 100 can be used for space conditioning with the bubble column dehumidifier. Furthermore, the system 100 can utilize various energy sources, including renewable energy sources like solar, further reducing its environmental impact.

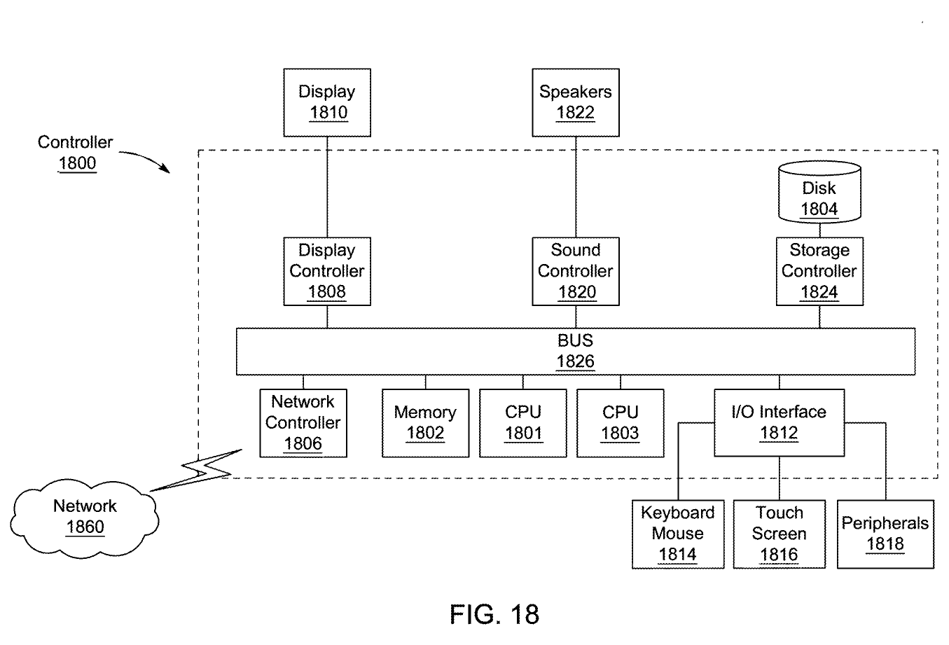

Next, further details of the hardware description of the computing environment according to exemplary embodiments is described with reference to FIG. 18. In FIG. 18, a controller 1800 is described embodying the system 100 of the present disclosure, in which the controller is a computing device which includes a CPU 1801 which performs the processes described above/below. The process data and instructions may be stored in memory 1802. These processes and instructions may also be stored on a storage medium disk 1804 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1801, 1803 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1801 or CPU 1803 may be a Xenon or Core processor from Intel of America or an Opteron processor from AMD of America, or may be other processor types that would be recognized by one of ordinary skill in the art. Alternatively, the CPU 1801, 1803 may be implemented on an FPGA, ASIC, PLD or using discrete logic circuits, as one of ordinary skill in the art would recognize. Further, CPU 1801, 1803 may be implemented as multiple processors cooperatively working in parallel to perform the instructions of the inventive processes described above.

The computing device in FIG. 18 also includes a network controller 1806, such as an Intel Ethernet PRO network interface card from Intel Corporation of America, for interfacing with network 1860. As can be appreciated, the network 1860 can be a public network, such as the Internet, or a private network such as an LAN or WAN network, or any combination thereof and can also include PSTN or ISDN sub-networks. The network 1860 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1808, such as a NVIDIA GeForce GTX or Quadro graphics adaptor from NVIDIA Corporation of America for interfacing with display 1810, such as a Hewlett Packard HPL2445w LCD monitor. A general purpose I/O interface 1812 interfaces with a keyboard and/or mouse 1814 as well as a touch screen panel 1816 on or separate from display 1810. General purpose I/O interface also connects to a variety of peripherals 1818 including printers and scanners, such as an OfficeJet or DeskJet from Hewlett Packard.

A sound controller 1820 is also provided in the computing device such as Sound Blaster X-Fi Titanium from Creative, to interface with speakers/microphone 1822 thereby providing sounds and/or music.

The general purpose storage controller 1824 connects the storage medium disk 1804 with communication bus 1826, which may be an ISA, EISA, VESA, PCI, or similar, for interconnecting all of the components of the computing device. A description of the general features and functionality of the display 1810, keyboard and/or mouse 1814, as well as the display controller 1808, storage controller 1824, network controller 1806, sound controller 1820, and general purpose I/O interface 1812 is omitted herein for brevity as these features are known.

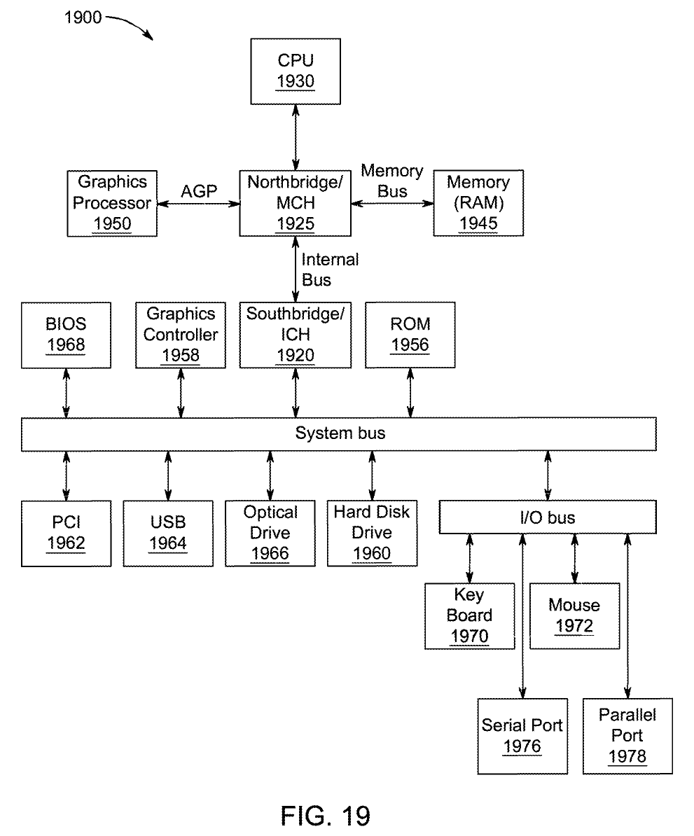

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 19.

FIG. 19 shows a schematic diagram of a data processing system, according to certain embodiments, for performing the functions of the exemplary embodiments. The data processing system is an example of a computer in which code or instructions implementing the processes of the illustrative embodiments may be located.

In FIG. 19, data processing system 1900 employs a hub architecture including a north bridge and memory controller hub (NB/MCH) 1925 and a south bridge and input/output (I/O) controller hub (SB/ICH) 1920. The central processing unit (CPU) 1930 is connected to NB/MCH 1925. The NB/MCH 1925 also connects to the memory 1945 via a memory bus, and connects to the graphics processor 1950 via an accelerated graphics port (AGP). The NB/MCH 1925 also connects to the SB/ICH 1920 via an internal bus (e.g., a unified media interface or a direct media interface). The CPU Processing unit 1930 may contain one or more processors and even may be implemented using one or more heterogeneous processor systems.

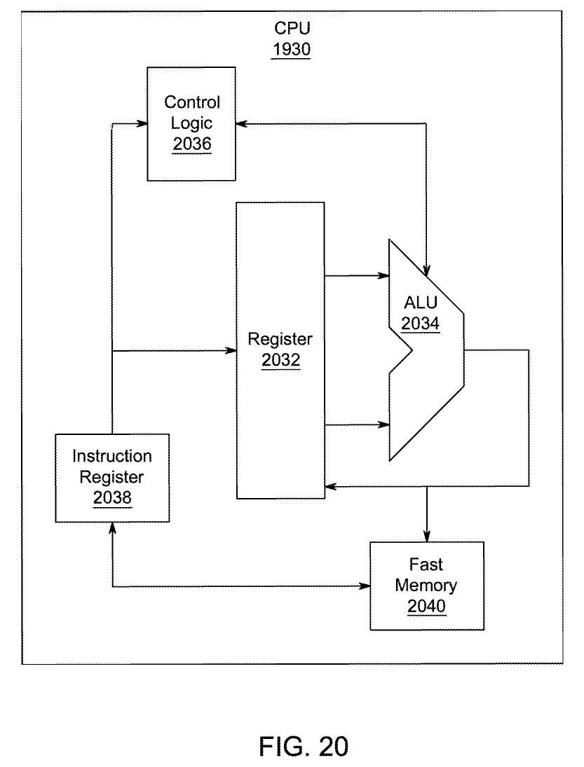

For example, FIG. 20 shows one implementation of CPU 1930. In one implementation, the instruction register 2038 retrieves instructions from the fast memory 2040. At least part of these instructions are fetched from the instruction register 2038 by the control logic 2036 and interpreted according to the instruction set architecture of the CPU 1930. Part of the instructions can also be directed to the register 2032. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 2034 that loads values from the register 2032 and performs logical and mathematical operations on the loaded values according to the instructions. The results from these operations can be feedback into the register and/or stored in the fast memory 2040. According to certain implementations, the instruction set architecture of the CPU 1930 can use a reduced instruction set architecture, a complex instruction set architecture, a vector processor architecture, a very large instruction word architecture. Furthermore, the CPU 1930 can be based on the Von Neuman model or the Harvard model. The CPU 1930 can be a digital signal processor, an FPGA, an ASIC, a PLA, a PLD, or a CPLD. Further, the CPU 1930 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 19, the data processing system 1900 can include that the SB/ICH 1920 is coupled through a system bus to an I/O Bus, a read only memory (ROM) 1956, universal serial bus (USB) port 1964, a flash binary input/output system (BIOS) 1968, and a graphics controller 1958. PCI/PCIe devices can also be coupled to SB/ICH 1988 through a PCI bus 1962.

The PCI devices may include, for example, Ethernet adapters, add-in cards, and PC cards for notebook computers. The Hard disk drive 1960 and CD-ROM 1966 can use, for example, an integrated drive electronics (IDE) or serial advanced technology attachment (SATA) interface. In one implementation the I/O bus can include a super I/O (SIO) device.

Further, the hard disk drive (HDD) 1960 and optical drive 1966 can also be coupled to the SB/ICH 1920 through a system bus. In one implementation, a keyboard 1970, a mouse 1972, a parallel port 1978, and a serial port 1976 can be connected to the system bus through the I/O bus. Other peripherals and devices that can be connected to the SB/ICH 1920 using a mass storage controller such as SATA or PATA , an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

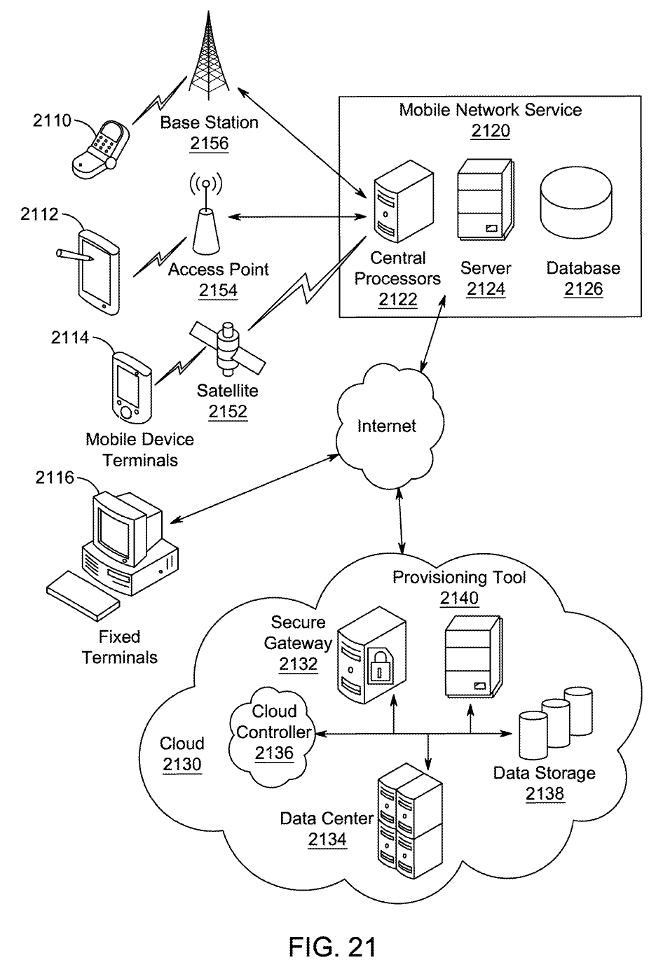

The functions and features described herein may also be executed by various distributed components of a system. For example, one or more processors may execute these system functions, wherein the processors are distributed across multiple components communicating in a network. The distributed components may include one or more client and server machines, such as cloud 2130 including a cloud controller 2136, a secure gateway 2132, a data center 2134, data storage 2138 and a provisioning tool 2140, and mobile network services 2120 including central processors 2122, a server 2124 and a database 2126, which may share processing, as shown by FIG. 21, in addition to various human interface and communication devices (e.g., display monitors 2116, smart phones 2110, tablets 2112, personal digital assistants (PDAs) 2114). The network may be a private network, such as a LAN, satellite 2152 or WAN 2154, or be a public network, may such as the Internet. Input to the system may be received via direct user input and received remotely in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A system for water desalination, comprising:
a membrane module, comprising:
a feed tank configured to receive salt water;
a heater configured to heat the salt water from the feed tank to form water vapor; and
a membrane distillation unit comprising in order, a feed chamber, a membrane and a vapor chamber, wherein the feed chamber is configured to receive the salt water and the water vapor from the heater, and the membrane is configured to let the water vapor pass from the feed chamber through the membrane to the vapor chamber,
an ejector module, comprising:
an ejector including a first inlet configured to receive a primary fluid stream and a second inlet configured to receive a secondary fluid stream so that the primary fluid stream and the secondary fluid stream mix to form a mixed stream; and
a freshwater tank configured to receive at least the water vapor of the mixed stream,
wherein the second inlet of the ejector is connected to an outlet of the vapor chamber so that the ejector is configured to receive the water vapor from the vapor chamber as the secondary fluid stream,
wherein the vapor chamber does not include an outlet that is configured to receive a sweeping gas,
wherein the vapor chamber is under a vacuum.

2. The system of claim 1, wherein the ejector is configured so that the primary fluid stream accelerates within the ejector to create the vacuum to suck the secondary fluid stream from the vapor chamber.

3. The system of claim 2, wherein the vacuum creates or enlarges a pressure differential across the membrane between the feed chamber and the vapor chamber to suck the water vapor from the feed chamber to the vapor chamber.

4. The system of claim 1, wherein the system does not comprise a vacuum pump.

5. The system of claim 1, wherein the membrane is a hydrophobic microporous membrane.

6. The system of claim 1, wherein:
the membrane module further comprises a water circulation pump.

7. The system of claim 6, wherein:
an outlet of the feed tank is operationally connected to an inlet of the water circulation pump,
an outlet of the water circulation pump is operationally connected to an inlet of the heater,
an outlet of the heater is operationally connected to an inlet of the feed chamber, and
an outlet of the feed chamber is operationally connected to an inlet of the feed tank.

8. The system of claim 1, wherein:
the primary fluid stream comprises water, and
the ejector module further comprises a water circulation pump.

9. The system of claim 8, wherein:
an outlet of the freshwater tank is operationally connected to an inlet of the water circulation pump,
an outlet of the water circulation pump is operationally connected to the first inlet of the ejector, and
an outlet of the ejector is operationally connected to an inlet of the freshwater tank.

10. The system of claim 1, wherein:
the primary fluid stream comprises air, and
the ejector module further comprises an air blower.

11. The system of claim 10, wherein:
an inlet of the air blower is configured to receive the air from an ambient environment,
an outlet of the air circulation pump is operationally connected to the first inlet of the ejector, and
an outlet of the ejector is operationally connected to an inlet of the freshwater tank.

12. The system of claim 11, further comprising a bubble column dehumidifier module that comprises n number of stages, wherein:
n is an integer from 1 to 100,
each stage comprises a bubble column,
a first stage is operationally connected to the outlet of the ejector to receive the mixed stream and is configured to capture a portion of the water vapor in the mixed stream to form desalinated water,
each bubble column comprises a vapor outlet through which a portion of the water vapor that is not captured in one stage is configured to pass a next stage, and
each bubble column comprises a desalinated water outlet operationally connected to the freshwater tank to collect the desalinated water.

13. The system of claim 12, further comprising:
a fan that is adjacent to the bubble column dehumidifier module.

14. The system of claim 12, further comprising:
n number of thermoelectric coolers, wherein the thermoelectric coolers are each adjacent to a respective bubble column.

15. The system of claim 12, further comprising:
a water cooling system configured to provide a circulating chilled water flow to each bubble column.

16. The system of claim 12, wherein:
a vapor outlet of a bubble column of a final stage of the bubble column dehumidifier module is operationally connected to the inlet of the air blower.

17. The system of claim 1, wherein:
the membrane module further comprises a power source configured to power the heater.

18. The system of claim 17, wherein the power source comprises solar power.

19. The system of claim 1, further comprising:
a control unit configured to control at least one selected from the group consisting of a temperature of the salt water in the water heater, a flow rate of the salt water, and a water level in the feed tank.

20. The system of claim 1, further comprising a series of membrane distillation units connected in parallel or series.
